(19) United States
(12) Patent Application Publication
(10) Pub. No.: US 2025/0018650 A1
(43) Pub. Date: Jan. 16, 2025

(54) SYSTEMS FOR CLEANING AND/OR COOLING ADDITIVELY MANUFACTURED OBJECTS AND ASSOCIATED METHODS

(71) Applicant: Align Technology, Inc., San Jose, CA (US)

(72) Inventors: Paramjot Singh, San Jose, CA (US); Viswanath Meenakshisundaram, Santa Clara, CA (US)

(21) Appl. No.: 18/771,688

(22) Filed: Jul. 12, 2024

Related U.S. Application Data
(60) Provisional application No. 63/513,405, filed on Jul. 13, 2023.
(60) Provisional application No. 63/580,081, filed on Sep. 1, 2023.

(51) Int. Cl. B29C 64/30; B29C 64/153; B29C 64/357; B29L 31/00; B33Y 10/00; B33Y 40/20; B33Y 80/00

(52) U.S. Cl. CPC B29C 64/30; B29C 64/357; B33Y 40/20; B33Y 80/00; B29C 64/153; B29L 2031/753; B33Y 10/00

(57) ABSTRACT

Systems and methods for processing additively manufactured objects are provided. In some embodiments, a method includes receiving one or more additively manufactured objects that are at least partially covered with a precursor material, cooling the one or more additively manufactured objects and the precursor material to a target temperature, and removing at least some of the precursor material from the one or more additively manufactured objects via application of mechanical force.

### CROSS-REFERENCE TO RELATED APPLICATION(S)

The present application claims the benefit of priority to U.S. Provisional Application No. 63/513,405, filed Jul. 13, 2023, and U.S. Provisional Application No. 63/580,081, filed Sep. 1, 2023, the disclosures of each of which are incorporated by reference herein in their entirety.

### TECHNICAL FIELD

The present technology generally relates to manufacturing, and in particular, to systems for cleaning and/or cooling additively manufactured objects.

### BACKGROUND

Additive manufacturing encompasses a variety of technologies that involve building up three-dimensional objects from multiple layers of material. For example, powder bed fusion techniques such as selective laser sintering use a powder as the raw material for fabricating an object. Conventionally, after fabrication, the object and the surrounding powder are at an elevated temperature, and are cooled passively within the print chamber before subsequent processing. The cooling process can take multiple hours (e.g., 10 to 24 hours), thus leading to significant machine downtime and low process yield. Moreover, the print chamber may lack functionality for accurately measuring the temperature of the object, which may result in the object being removed before it is adequately cooled or excessively long cooling times. Removal of the object from the print chamber for cooling poses several difficulties, including oxidation of the powder material upon exposure to air, as well as warping, distortion, and deterioration in mechanical properties of the object when subjected to sudden uncontrolled temperature changes. Conventionally, after cooling, the object is manually separated from the surrounding powder and manually brushed to remove excess powder remaining on the object. This manual cleaning process is time- and labor-intensive, presents safety risks to the operator due to powder exposure, and is poorly suited for large-scale manufacturing.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram of a method for fabricating and post-processing an additively manufactured object, in accordance with embodiments of the present technology.

FIG. 2A is a partially schematic diagram of a system for additive manufacturing, in accordance with embodiments of the present technology.

FIG. 2B is a partially schematic diagram of an object in a powder cake produced by the system of FIG. 2A.

FIG. 2C is a partially schematic diagram of the object of FIG. 2B after cleaning.

FIG. 3 is a partially schematic illustration of a system for fabricating and post-processing additively manufactured objects, in accordance with embodiments of the present technology.

FIG. 4 is a schematic diagram providing a general overview of a system for fabricating and cooling additively manufactured objects, in accordance with embodiments of the present technology.

FIG. 5 is a partially schematic illustration of a transport device configured in accordance with embodiments of the present technology.

FIGS. 6A-6C are partially schematic illustrations of a method for loading an additively manufactured object into the transport device of FIG. 5, in accordance with embodiments of the present technology.

FIGS. 7A-7C are partially schematic illustrations of another method for loading an additively manufactured object into the transport device of FIG. 5, in accordance with embodiments of the present technology.

FIG. 8 is a partially schematic illustration of a cooling system configured in accordance with embodiments of the present technology.

FIG. 9 is a partially schematic illustration of a temperature probe of the cooling system of FIG. 8, in accordance with embodiments of the present technology.

FIG. 10 is a flow diagram illustrating a method for processing an additively manufactured object, in accordance with embodiments of the present technology.

FIG. 11 is a schematic diagram providing a general overview of a system for cleaning additively manufactured objects, in accordance with embodiments of the present technology.

FIGS. 12A-12C are partially schematic illustrations of a transfer process for additively manufactured objects, in accordance with embodiments of the present technology.

FIGS. 13A-13C are partially schematic illustrations of a transfer process for additively manufactured objects, in accordance with embodiments of the present technology.

FIG. 14 is a partially schematic side view of a centrifuge for cleaning additively manufactured objects, in accordance with embodiments of the present technology.

FIG. 15 is a partially schematic side view of a brush assembly for cleaning additively manufactured objects, in accordance with embodiments of the present technology.

FIG. 16 is a partially schematic side view of a brush assembly for cleaning additively manufactured objects, in accordance with embodiments of the present technology.

FIG. 17 is a flow diagram illustrating a method for processing an additively manufactured object, in accordance with embodiments of the present technology.

FIG. 18A illustrates a representative example of a tooth repositioning appliance configured in accordance with embodiments of the present technology.

FIG. 18B illustrates a tooth repositioning system including a plurality of appliances, in accordance with embodiments of the present technology.

FIG. 18C illustrates a method of orthodontic treatment using a plurality of appliances, in accordance with embodiments of the present technology.

FIG. 19 illustrates a method for designing an orthodontic appliance, in accordance with embodiments of the present technology.

FIG. 20 illustrates a method for digitally planning an orthodontic treatment and/or design or fabrication of an appliance, in accordance with embodiments of the present technology.

### DETAILED DESCRIPTION

The present technology relates to processing of additively manufactured objects such as dental appliances. In some embodiments, for example, a system for cooling one or more additively manufactured objects is provided. The system can include a plurality of compartments. Each compartment includes a chamber configured to receive a set of additively manufactured objects, a port configured to fluidically couple the chamber to a source of an inert gas, and a sensor configured to generate sensor data indicative of a cooling status of the set of additively manufactured objects. The system can also include a controller operably coupled to the plurality of compartments. The controller can be configured to monitor the cooling status of the set of additively manufactured objects within each compartment based on the corresponding sensor data.

In some embodiments, the present technology provides a transport device configured to transfer the set of additively manufactured objects from an additive manufacturing system to a cooling system. The transport device can be a cart having a plurality of wheels. The transport device can include a chamber configured to receive the set of additively manufactured objects. The chamber can be thermally insulated and/or fluidically isolated from the surrounding environment. Optionally, the chamber can be fluidly coupled to a reservoir of inert gas for purging external air from the chamber.

In some embodiments, a system is provided for processing one or more additively manufactured objects that are at least partially covered with a precursor material (e.g., a polymeric powder). The system can include a cleaning station that is configured to agitate (e.g., vibrate and/or rotate) the additively manufactured objects to remove at least some of the precursor material from the additively manufactured objects. The system can also include a brush assembly configured to brush the additively manufactured objects to remove at least some of the precursor material from the additively manufactured objects. The system can further include a conveyor configured to transport the one or more additively manufactured objects from the cleaning station to the brush assembly.

The present technology can provide various advantages compared to conventional approaches for processing additively manufactured objects. For instance, the techniques described herein for object cooling can reduce downtime and improve process yield of additive manufacturing systems by providing a separate system for cooling the additively manufacturing objects, thus allowing the additive manufacturing system to be immediately used again to fabricate additional objects. Moreover, the cooling of the objects can occur in a temperature- and atmosphere-controlled environment, thus avoiding issues such as oxidation due to exposure to ambient air, and/or distortion and/or deterioration in mechanical properties of the objects due to excessive temperature fluctuations. Additionally, the cooling of the objects can be actively monitored and controlled, thus ensuring that the objects are cooled according to a desired cooling profile, which may be customized based on the object type, number of objects, material type, size of the powder cake, and/or other relevant characteristics.

In some embodiments, the cleaning systems described herein operate in a semi-automated or fully automated manner, such that the additively manufactured objects can be rapidly and effectively cleaned with little or no intervention from a human operator. The systems herein can drastically reduce the time required for cleaning additively manufactured objects, as well as reduce or eliminate the need for manual cleaning steps, thus allowing for large scale processing of additively manufactured objects. Moreover, the systems herein can also provide automated recovery and handling of the precursor material, which can improve yield for reuse and reduce health risks associated with powder exposure.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Systems and Methods for Processing Additively Manufactured Objects

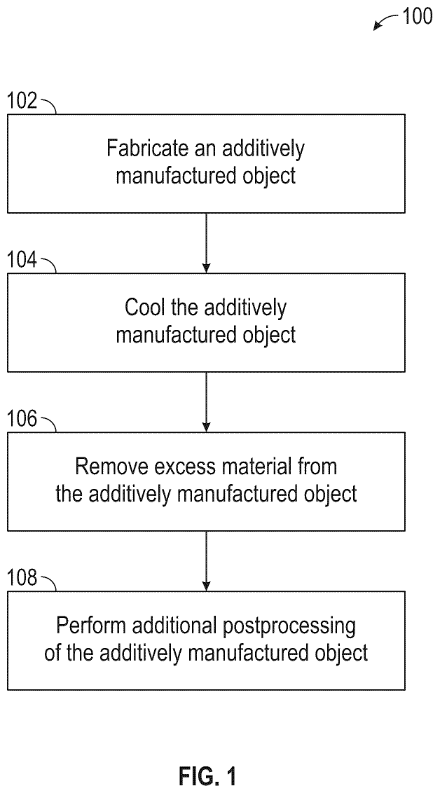

FIG. 1 is a flow diagram providing a general overview of a method 100 for fabricating and processing an additively manufactured object, in accordance with embodiments of the present technology. The method 100 can be used to produce many different types of additively manufactured objects, such as orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The method 100 begins at block 102 with fabricating an additively manufactured object. Additive manufacturing (also referred to herein as “3D printing”) includes a variety of technologies which fabricate 3D objects directly from digital models through an additive process. In some embodiments, additive manufacturing includes depositing a precursor material (e.g., a polymeric powder) onto a build platform. The precursor material can be sintered, fused, melted, cured, polymerized, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

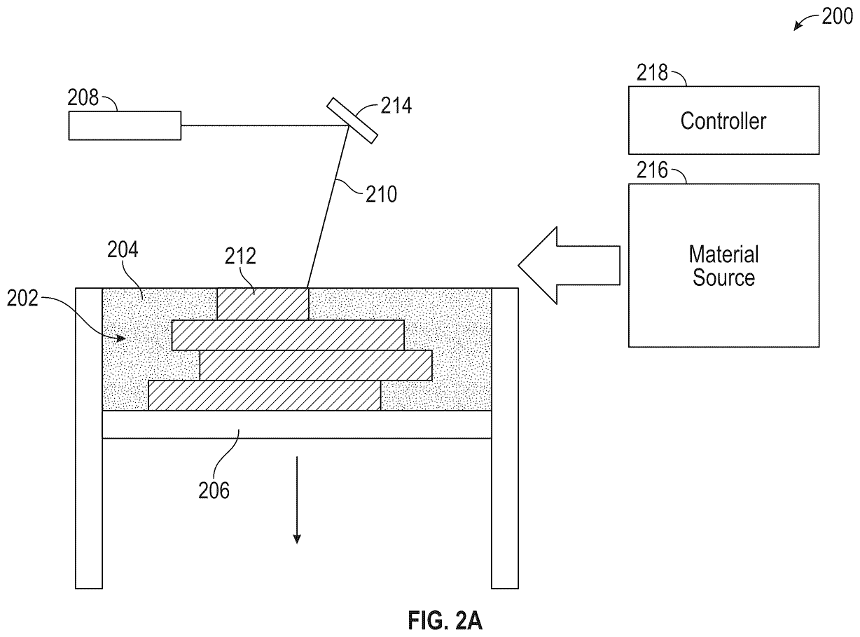

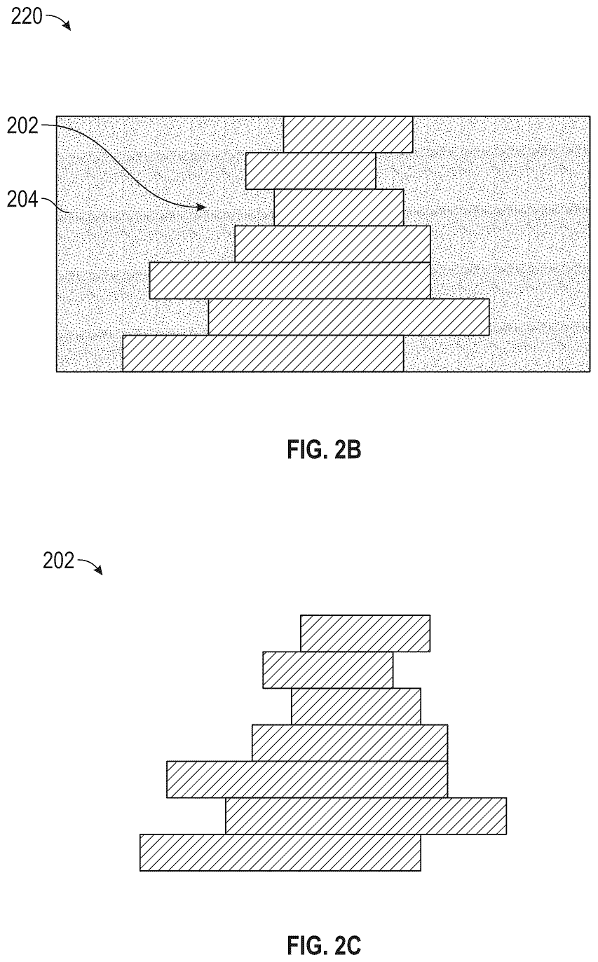

For example, FIG. 2A is a partially schematic diagram of an additive manufacturing system 200 configured in accordance with embodiments of the present technology. The system 200 is configured to fabricate an additively manufactured object 202 (“object 202”) using a powder bed fusion technique, such as selective laser sintering (SLS). As shown in FIG. 2A, the system 200 includes a bed of powder 204 (e.g., polymeric powder) on a build platform 206. The system 200 also include an energy source 208 (e.g., a laser source or electron beam source) that outputs energy 210 (e.g., a laser or electron beam) at an intensity configured to sinter, melt, or otherwise fuse the powder 204 into a cohesive object layer 212 on the build platform 206 and/or a previously formed portion of the object 202. A scanner 214 (e.g., a mirror and/or other optical elements) can be used to direct the energy 210 into a suitable pattern on the powder 204 to form the object layer 212. The geometry of the object layer 212 can correspond to the desired geometry for a corresponding cross-section of the object 202.

Once the object layer 212 has been formed, the build platform 206 can be lowered by a predetermined amount. A material source 216 (shown schematically) can then apply a fresh layer of powder 204 onto the formed object layer 212 and previously deposited powder 204. For example, the material source 216 can include a reservoir of powder 204 (e.g., hopper, feed cartridge with movable piston) and/or a smoothing device (e.g., doctor blades, recoater blades, rollers) that applies and smooths the deposited powder 204 into a thin, uniform layer. The energy 210 can then be applied to the fresh layer of powder 204 to form the next object layer 212. The fabrication process can be repeated to iteratively build up individual object layers 212 on the build platform 206 until the object 202 is complete. The object 202 can then be removed from the system 200 for post-processing, as described elsewhere herein.

In some embodiments, the system 200 also includes a controller 218 that is operably coupled to the build platform 206, energy source 208, and material source 216 to control the operation thereof. The controller 218 can be or include a computing device including one or more processors and memory storing instructions for performing the additive manufacturing operations described herein. For example, the controller 218 can receive a digital data set (e.g., a 3D model or a plurality of 2D slices) representing the object 202 to be fabricated, determine a plurality of object cross-sections to build up the object 202 from the powder 204, and can transmit instructions to the energy source 208 to output energy 210 to form a plurality of object layers 212 corresponding to the object cross-sections. Additionally, the controller 218 can also determine and control other operational parameters, such as the positioning of the build platform 206 (e.g., height) and/or the amount of powder 204 deposited by the material source 216.

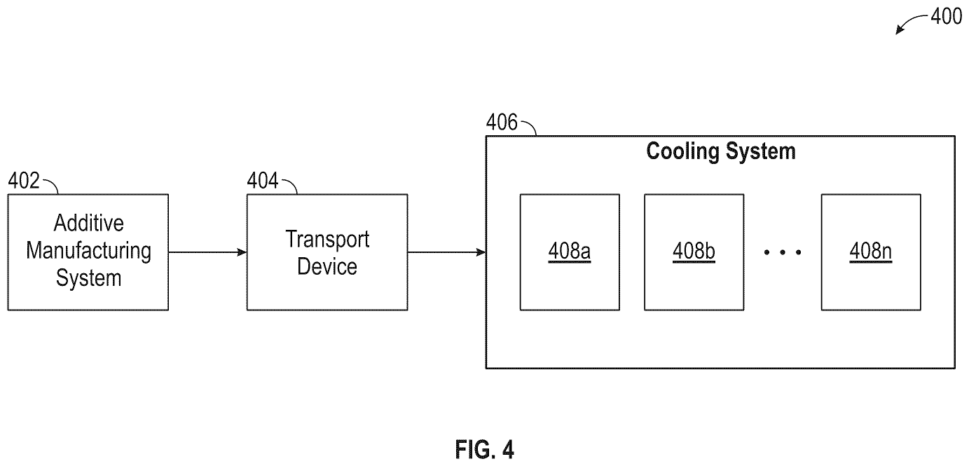

Referring again to FIG. 1, after the additively manufactured object is fabricated, the object can undergo one or more additional process steps, also referred to herein as “post-processing.” For example, at block 104, the additively manufactured object can be cooled after fabrication. The energy involved in certain types of additive manufacturing processes can result in heating of the object and/or surrounding precursor material to an elevated temperature. For instance, the energy used in a powder bed fusion process such as SLS can heat the object and/or surrounding powder to a temperature of 100° C., 125° C., 150° C., 160° C., 170° C., 180° C., 190° C., 200° C., or more. Accordingly, the object and/or surrounding material may need to be cooled to a lower temperature before subsequent processing, such as a temperature less than or equal to 100° C., 90° C., 80° C., 70° C., 60° C., 50° C., 30° C., or 25° C. The cooling process can take at least 1 hour, 2 hours, 4 hours, 8 hours, 10 hours, 12 hours, or 24 hours. In some embodiments, to reduce downtime of the additive manufacturing system, the object is removed from the additive manufacturing system and transport the object to a separate cooling system. The cooling system can also include environmental control mechanisms to avoid exposing the object to excessive temperature fluctuations and/or oxidizing conditions. Examples of cooling systems and associated devices and methods are described in detail below in connection with FIGS. 4-10.

At block 106, the method 100 can continue with removing excess material from the additively manufactured object. The excess material can include unincorporated precursor material (e.g., unsintered powder) and/or other unwanted material (e.g., debris) that remains on and/or within the object after the additive manufacturing process. The excess material can be removed in many different ways, such as by applying mechanical forces to the object (e.g., vibration, centrifugation, tumbling, brushing), exposing the object to a solvent (e.g., via spraying, immersion), heating or cooling the object, applying a vacuum to the object, blowing a pressurized gas onto the object, and/or other suitable techniques. Optionally, the excess material can be collected and/or processed for reuse.

For example, referring to FIG. 2B, the output of a powder bed fusion process can be a powder cake 220 containing the object 202 embedded within the unsintered powder 204. Depending on the size of the object 202, the powder 204 can constitute a relatively large volume of the powder cake 220, such as at least 50%, 60%, 70%, 80%, or 90% of the total volume of the powder cake 220. Post-processing of the object 202 can include extracting the object 202 from the powder cake 220 (“decaking”) and removing residual powder 204 adhered to the surfaces of the object 202 (“depowdering”) to produce a cleaned object 202 (FIG. 2C). Optionally, some or all of the removed powder 204 can be collected and/or processed for reuse.

Referring again to FIG. 1, at block 106, the method 100 can optionally include performing additional post-processing of the object. For example, the additional post-processing can include modifying at least one surface of the object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface modifications include removing material from the object, e.g., by polishing, abrading, blasting, etc. Alternatively or in combination, the surface modifications can include applying an additional material to the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., a dental appliance worn on the teeth); coloring and/or applying other aesthetic features to the object; improving scratch resistance and/or other mechanical properties; providing antimicrobial properties; and incorporating therapeutic agents into the object for controlled release.

Other examples of additional post-processing that may be performed include, but are not limited to, additional cleaning of the object (e.g., washing with water, solvents, etc.); post-curing and/or annealing the additively manufactured object; trimming or otherwise separating the object from any substrates, supports, and/or other structures that are not intended to be present in the final product; and packaging the object for shipment.

The method 100 illustrated in FIG. 1 can be modified in many different ways. For example, although the above processes of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied. Some of the processes of the method 100 can be omitted, such as the processes of any of blocks 104, 106, or 108. The method 100 can also include additional processes not shown in FIG. 1.

Moreover, although the method 100 is described in connection with FIGS. 2A-2C, which depict additive manufacturing of an object utilizing a powder bed fusion process, this is not intended to be limiting, and the method 100 can be applied to objects fabricated using other types of additive manufacturing systems and processes, such as the examples provided in Section III below.

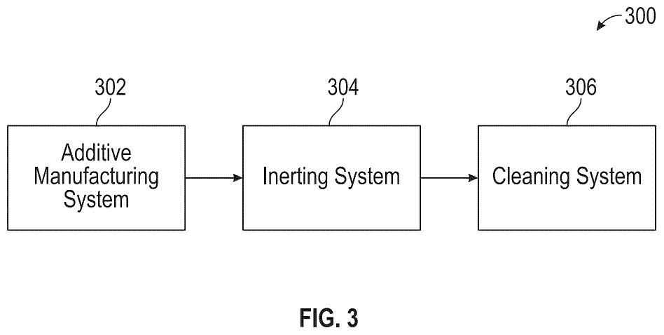

FIG. 3 is a partially schematic illustration of a system 300 for fabricating and post-processing additively manufactured objects, in accordance with embodiments of the present technology. The system 300 can be used to produce many different types of additively manufactured objects, such as dental appliances. As shown in FIG. 3, the system 300 can include an additive manufacturing system 302, an inerting system 304, and a cleaning system 306. The additive manufacturing system 302 can be any of the embodiments described herein (e.g., the system 200 of FIG. 2A) and can implement any of the additive manufacturing techniques described herein (e.g., a powder bed fusion process such as SLS).

Once the additive manufacturing process is complete, the additively manufactured objects can be removed from the additive manufacturing system 302 and transferred to the inerting system 304. The transfer process can be performed by a human operator, by a robotic assembly (e.g., using a moving belt, roller, robotic arm, etc.), or suitable combinations thereof. In some embodiments, the objects are transferred to the inerting system 304 together with remaining precursor material from the additive manufacturing process, e.g., as part of a powder cake that includes the objects embedded in unsintered powder.

The inerting system 304 can be configured to allow the objects and/or remaining precursor material to reach a desired state for further processing within a controlled environment. In some embodiments, for example, the objects and/or precursor material may be cooled to a target temperature while in an inert environment that protects the objects and/or precursor material from conditions that might cause undesirable chemical reactions (e.g., oxidation reactions), warping, shrinkage, etc. Representative examples of systems, devices, and methods for cooling additively manufactured objects in a controlled manner are described further below in connection with FIGS. 4-10.

Once the inerting process is complete, the additively manufactured objects can be removed from the inerting system 304 and transferred to the cleaning system 306. The transfer process can be performed by a human operator, by a robotic assembly (e.g., using a moving belt, roller, robotic arm, etc.), or suitable combinations thereof. In some embodiments, the objects are transferred to the cleaning system 306 together with the remaining precursor material, e.g., as part of a powder cake that includes the objects embedded in unsintered powder.

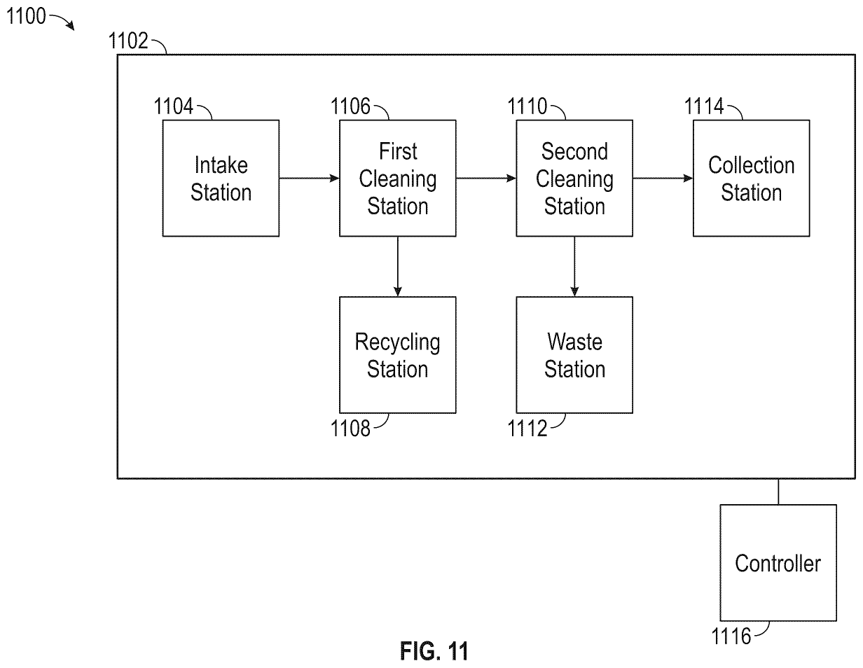

The cleaning system 306 can be configured to remove most or all of the remaining precursor material from the additively manufactured objects. The precursor material can be removed in many different ways, such as by applying mechanical forces to the object (e.g., vibration, centrifugation, tumbling, brushing), exposing the object to a solvent (e.g., via spraying, immersion), heating or cooling the object, applying a vacuum to the object, blowing a pressurized gas onto the object, and/or other suitable techniques. Optionally, the precursor material can be collected and/or processed for reuse. Representative examples of systems, devices, and methods for cleaning additively manufactured objects are described further below in connection with FIGS. 11-17.

The system 300 illustrated in FIG. 3 can be modified in many ways. In some embodiments, for example, the inerting system 304 is optional, such that the additively manufactured objects and/or remaining precursor material can be transferred directly from the additive manufacturing system 302 to the cleaning system 306. Alternatively, the cleaning system 306 can be optional, such that the objects are transferred to a different post-processing system after the inerting system 304. Moreover, the system 300 can include additional post-processing systems not shown in FIG. 3. Any of the components illustrated in the system 300 can operate automatically (e.g., under the control of a computing device such as a controller), can be operated manually, or suitable combinations thereof.

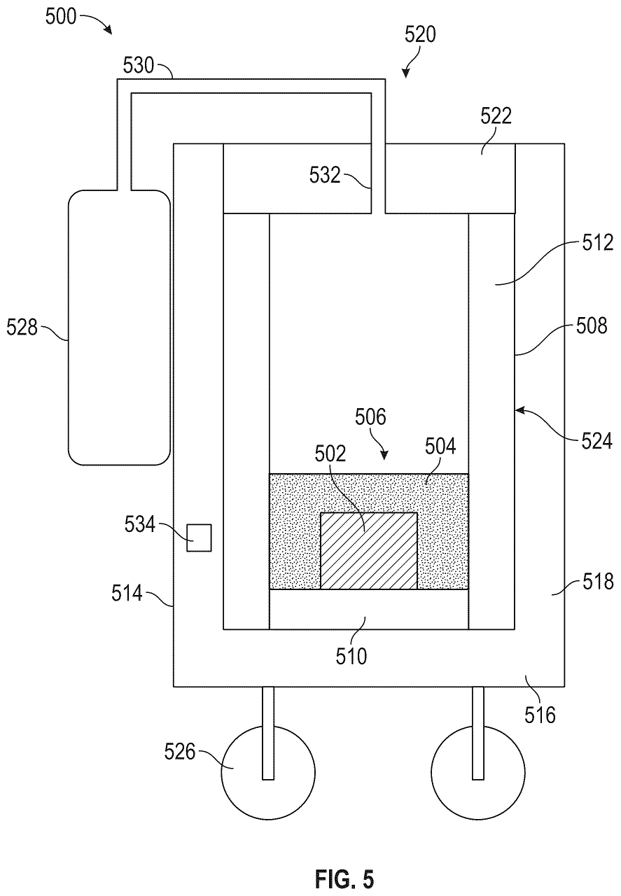

FIGS. 4-10 illustrate systems, devices, and methods for cooling additively manufactured objects, in accordance with embodiments of the present technology. Specifically, FIG. 4 is a schematic diagram providing a general overview of a system 400 for fabricating and cooling additively manufactured objects, and FIGS. 5-10 illustrate representative examples of systems, devices, and methods for cooling additively manufactured objects. Although certain aspects of FIGS. 4-10 are described in connection with additively manufactured objects fabricated from a powder, these embodiments can be adapted for use with objects fabricated from other types of precursor materials and/or other additive manufacturing processes.

Referring first to FIG. 4, the system 400 includes an additive manufacturing system 402 for fabricating one or more additively manufactured objects, such as one or more dental appliances. The additive manufacturing system 402 can be any of the embodiments described herein (e.g., the system 200 of FIG. 2A and/or the system 302 of FIG. 3) and can implement any of the additive manufacturing techniques described herein (e.g., a powder bed fusion process such as SLS).

Once the additive manufacturing process is complete, the additively manufactured objects can be removed from the additive manufacturing system 402 and transferred to a transport device 404. The transfer process can be performed by a human operator, by a robotic assembly (e.g., using a moving belt, roller, robotic arm, etc.), or suitable combinations thereof. In some embodiments, the objects are removed together with remaining precursor material from the additive manufacturing process (e.g., unsintered powder). The objects can be removed from the additive manufacturing system 402 in a build container that was used to support the objects during the additive manufacturing process, or may be removed without the build container.

The transport device 404 is used to transfer one or more additively manufactured objects from the additive manufacturing system 402 to a cooling system 406. The transport device 404 can include an enclosed chamber that houses the additively manufactured objects in a controlled environment to avoid exposing the objects and/or the remaining precursor material to conditions that might detrimentally affect their properties during the transfer process. For instance, the enclosed chamber of the transport device 404 can fluidically isolate the objects and/or remaining precursor material from air in the surrounding environment to avoid oxidation (e.g., polymeric powders used in powder bed fusion may oxidize upon exposure to oxygen and become unsuitable for reuse). The transport device 404 can optionally introduce an inert gas into the enclosed chamber to purge out any air that may be present and/or to prevent entry of external air.

The transport device 404 can control the temperature of the objects and/or remaining precursor material, e.g., to avoid rapid cooling and/or excessive temperature fluctuations that may cause warping, shrinkage, changes to mechanical properties, and/or other detrimental effects on the objects. In such embodiments, the enclosed chamber can be thermally isolated from the surrounding environment and/or can include temperature control mechanisms (e.g., heating and/or cooling devices, insulating materials) to maintain the objects and/or precursor material within a desired temperature range.

Other components that can be included in the transport device 404 include any of the following: handles or other similar structures to allow for gripping and/or manipulating the transport device 404; wheels to facilitate pushing of the transport device 404 in embodiments where the transport device 404 is a cart, trolley, or other movable device; sensors to monitor status of the objects, precursor material, and/or inert gas source (e.g., temperature sensors, pressure sensors, flow sensors, weight sensors); and/or controllers to control the operation of the various components of the transport device 404. The transport device 404 can be operated by a human user, by an automated system (e.g., by a robotic assembly), or a suitable combination thereof.

The additively manufactured objects can be transferred from the transport device 404 to the cooling system 406. The transfer process can be performed by a human operator, by a robotic assembly (e.g., using a moving belt, roller, robotic arm, etc.), or suitable combinations thereof. The objects can be transferred to the cooling system 406 in the build container that was used to support the objects during the additive manufacturing process, or may be transferred to the cooling system 406 without the build container.

The cooling system 406 houses the additively manufactured objects in a controlled environment to allow the objects to cool to a target temperature. As shown in FIG. 4, the cooling system 406 can include a plurality of compartments 408a-408n (collectively, “compartments 408”), with each compartment 408 configured to receive a respective batch of objects (e.g., a plurality of objects that are fabricated during the same additive manufacturing operation and/or are located within the same build container). The cooling system 406 can include any suitable number of compartments 408, such as one, two, three, four, five, 10, 20, 50, or more compartments 408.

During the cooling process, the cooling system 406 can control the temperature of the objects and/or any precursor material, e.g., to avoid rapid cooling and/or excessive temperature fluctuations that may cause warping, shrinkage, changes to mechanical properties, and/or other detrimental effects on the objects. Accordingly, each compartment 408 can be thermally isolated from the surrounding environment and/or from the other compartments 408. The compartments 408 can also include temperature control mechanisms (e.g., heating and/or cooling devices, insulating materials) to maintain the objects and/or precursor material in the compartment 408 within a desired temperature range. The compartments 408 can optionally include a temperature sensor to monitor the cooling of the objects and/or precursor material, and/or to alert an operator when the objects and/or precursor material have cooled to the target temperature. Optionally, the temperature of each compartment 408 is independently controllable to allow each batch of objects to cool at its own rate.

The cooling system 406 can also isolate the objects and/or precursor material from external conditions that might detrimentally affect their properties during the cooling process. For instance, each compartment 408 can fluidically isolate the objects and/or remaining precursor material from air in the surrounding environment to avoid oxidation. The cooling system 406 can introduce an inert gas into each compartment 408 to purge out any air that may be present and/or to prevent entry of external air. Optionally, the gas flow rate and/or pressure within each compartment 408 can be individually controlled.

In some embodiments, the cooling system 406 includes at least one controller to control the operation of the various components of the cooling system 406. The controller can be operably coupled to each compartment 408 to allow the conditions within each compartment 408 to be independently monitored and controlled. When a batch of objects within a compartment 408 is cooled to the target temperature, the controller can generate a notification signal that is displayed to a human operator and/or transmitted to an automated system, so that the objects can be removed from the cooling system 406 for subsequent post-processing.

The configuration of the system 400 can be modified in many ways. For example, the transport device 404 can be omitted in some embodiments, such that the additively manufactured objects are transferred directly from the additive manufacturing system 402 to the cooling system 406. Moreover, the system 400 can include other components not shown in FIG. 4, such as sensors, user interface devices, and/or transport mechanisms to route objects and/or materials between the additive manufacturing system 402, transport device 404, and/or cooling system 406.

FIG. 5 is a partially schematic illustration of a transport device 500 configured in accordance with embodiments of the present technology. The transport device 500 can be used as the transport device 404 of FIG. 4 and/or can include any of the features of the transport device 404. The transport device 500 is used to transfer an additively manufactured object 502 from a first location (e.g., the location of the additive manufacturing system 402 of FIG. 4) to a second location (e.g., the location of the cooling system 406 of FIG. 4). Although a single object 502 is shown in FIG. 5, the transport device 500 can be used for any suitable number of objects 502, such as two, three, four, five, 10, 20, 50, or more objects 502. In some embodiments, the object 502 is embedded within a mass of precursor material 504. For instance, the object 502 can be fabricated via SLS or other powder bed fusion process, and the precursor material 504 can be a powder. The combination of the object 502 and the precursor material 504 may be referred herein as a “powder cake 506.” However, in other embodiments, the object 502 can be present without any precursor material 504.

The powder cake 506 can be provided within a build container 508. The build container 508 can be a bin, tank, vat, frame, etc., that contains the object 502 and the precursor material 504 during additive manufacturing, and can be a standard component of the additive manufacturing system. In some embodiments, the build container 508 includes a bottom wall that serves as the build platform for the object 502 during the additive manufacturing process, and a plurality of sidewalls 512 that contain the bed of precursor material 504 that is deposited during the additive manufacturing process. The top of the build container 508 can be open to provide access to the powder cake 506.

The transport device 500 can include a housing 514 including an interior cavity to receive the build container 508, such as a case, sheath, bin, jacket, or other enclosure. In the illustrated embodiment, the housing 514 includes a bottom wall 516 and a plurality of sidewalls 512, and an upper opening 520. Alternatively, the opening 520 can instead be located in a sidewall 512 of the housing 514. The transport device 500 can also include a lid 522 configured to fit against and seal the opening 520 of the housing 514. Accordingly, the housing 514 and lid 522 can collectively form an enclosed chamber 524 containing the build container 508. In some embodiments, the lid 522 is opened and closed manually by a human operator, while in other embodiments, the lid 522 is coupled to an actuator (e.g., a piston, hydraulics—not shown) that opens and closes the lid 522.

In the illustrated embodiment, the transport device 500 is configured as a cart having a plurality of wheels 526. For instance, a human operator or a robot can push or pull the transport device 500 to the destination. The transport device 500 can optionally include one or more handles (not shown) for maneuvering the transport device 500. In other embodiments, however, the wheels 526 can be omitted and the handle(s) can be used to carry the transport device 500. For instance, a human operator or robot can lift and carry the transport device 500 to the destination, or can place the transport device 500 upon a conveyor or other automated mechanism that transfers the transport device 500 to the destination. The transport device 500 can optionally include additional components to facilitate transfer of the build container 508 from its initial location to its destination, such as an actuator to raise and lower the housing 514 to different heights to accommodate the height of the initial location and/or destination.

In some embodiments, the transport device 500 is configured to isolate the powder cake 506 from the surrounding environment in order to avoid exposing the powder cake 506 to gases in the ambient air that may react with the object 502 and/or precursor material 504, such as oxygen. Thus, the lid 522 can include one or more gaskets that seal against the housing 514 so that the chamber 524 enclosing the build container 508 is fluidically sealed from the external environment. The transport device 500 can also include a reservoir 528 of an inert gas, such as nitrogen, argon, helium, or combinations thereof. The reservoir 528 can be a cylinder, tank, or other container that is coupled to the housing 514. The reservoir 528 can be fluidically connected to the enclosed chamber formed by the housing 514 and the lid 522 via at least one fluid line 530 (e.g., a tube, pipe, or other connector). In the illustrated embodiment, the lid 522 includes a port 532 and the fluid line 530 is coupled to the port, such that the inert gas can enter the chamber 524 to create an inert atmosphere surrounding the powder cake 506. In other embodiments, however, the port 532 can alternatively or additionally be located in the housing 514. Optionally, the lid 522 and/or housing 514 can include one or more one-way valves (not shown) that allow any air that is initially within the chamber 524 to be purged out of the chamber 524 by introduction of the inert gas, but prevent external air from entering the chamber 524.

In some embodiments, the transport device 500 is configured to control the temperature of the powder cake 506. For instance, the transport device 500 can maintain the temperature of the powder cake 506 within a target range, such as a temperature within 20° C., 15° C., 10° C., or 5° C. of an initial temperature of the powder cake 506 when the powder cake 506 is first placed into the transport device 304. Alternatively or in combination, the transport device 500 can regulate the cooling rate of the powder cake 506, e.g., to a rate less than or equal to 10° C./min, 5° C./min, 2° C./min, 1° C./min, 0.5° C./min, or 0.1° C./min. The control of the temperature and/or cooling rate can reduce or prevent deformation, shrinkage, and/or other undesirable changes to the properties of the object 502 due to excessively fast cooling.

In some embodiments, the transport device 500 controls the temperature and/or cooling rate by thermally isolating the build container 508 (and thus, the powder cake 506) from the surrounding environment in order to control the temperature of the powder cake 506. For instance, the housing 514 and/or lid 522 can be made partially or entirely from one or more thermally insulative materials, and/or can be partially or entirely coated with one or more thermally insulative materials. Examples of thermally insulative materials that can be used include foams (e.g., polystyrene foam, urethane foam), fiberglass, mineral wool, cellulose-based materials, and combinations thereof.

Alternatively or in combination, the transport device 500 can include one or more active temperature control elements (not shown), such as one or more heating devices (e.g., heat sinks, heating plates, heat lamps, heated fluid) and/or one or more cooling devices (e.g., thermoelectric coolers, cold plates, cooled fluid). The active temperature control elements can be located at any suitable portion of the transport device 500, such as on an interior surface of the housing 514, on an exterior surface of the housing 514, within a wall of the housing 514, on an interior surface of the lid 522, on an exterior surface of the lid 522, within the lid 522, or a suitable combination thereof. Optionally, the inert gas can be heated and/or cooled to control the temperature of chamber 524.

In some embodiments, the transport device 500 can include one or more sensors 534 to monitor the operation of the transport device 500 and/or provide feedback for controlling the operation of the transport device 500. For example, the sensor 534 can be configured to detect whether the build container 508 is present within the transport device 500. In such embodiments, the sensor 534 can be a weight sensor that detects the presence of the build container 508 based on weight. The weight data produced by the weight sensor can optionally be used to adjust the operation of the transport device 500 (e.g., a lower weight may correspond to a smaller powder cake 506, and thus more inert gas may be needed to fill the larger empty space within the build container 508; the cooling rate of the powder cake 506 may vary depending on its size, and the operation of the active temperature control elements may be varied accordingly). As another example, the sensor 534 can be a switch that is triggered when the build container 508 is loaded into the chamber 524, such as a mechanical, pressure-activated switch, etc.

As another example, the sensor 534 can be a temperature sensor, such a thermistor, a thermocouple, or an infrared sensor. The temperature sensor can measure the temperature of the powder cake 506 indirectly (e.g., by measuring the temperature within the chamber 524) or directly (e.g., measuring the surface temperature of the powder cake 506 using an infrared sensor, and/or measuring the interior temperature of the powder cake 506 using a temperature probe that is inserted into the powder cake 506). The temperature data produced by the temperature sensor can be used to control the operation of the transport device 500, such as by adjusting the heating and/or cooling provided by the active temperature control elements.

Other types of sensors 534 that can be included in the transport device 500 include optical sensors, distance sensors, force sensors, pressure sensors, strain sensors, motion sensors, or position sensors, or suitable combinations thereof.

Although the sensor 534 is depicted as being embedded within a sidewall 518 of the housing 514, the sensor 534 can also be positioned at other locations of the transport device 500, such as within a bottom wall 516 of the housing 514, on an interior surface of the housing 514, on an exterior surface of the housing 514, embedded within the lid 522, on an interior surface of the lid 522, on an exterior surface of the lid 522, within the chamber 524, or within the reservoir 528. Moreover, although FIG. 5 depicts a single sensor 534, the transport device 500 can alternatively include a plurality of sensors 534, such as two, three, four, five, or more sensors 534. Some or all of the sensors 534 can be positioned at the same location, or some or all of the sensors 534 can be positioned at different locations. Some or all of the sensors 534 can be the same sensor type, or some or all of the sensor 534 can be different sensor types.

The transport device 500 can optionally include a controller (not shown) to monitor and/or control the operation of the transport device 500. The controller can be or include a computing device including one or more processors and memory storing instructions for performing the operations described herein. For example, the controller can perform some or all of the following operations: opening and closing the lid 522, monitoring loading of the build container 508 into the chamber 524, initiating a purge of air within the chamber 524, controlling the flow rate of the inert gas into the chamber 524, monitoring the pressure within the chamber 524 via one or more sensors 534, monitoring the temperature within the chamber 524 via one or more sensors 534, monitoring the temperature of the powder cake 506 via one or more sensors 534, controlling the operation of one or more active temperature control elements based on sensor feedback, and/or generating alerts to notify an operator of error conditions (e.g., excessive temperature fluctuations, loss of pressure within the chamber 524 indicative of a leak).

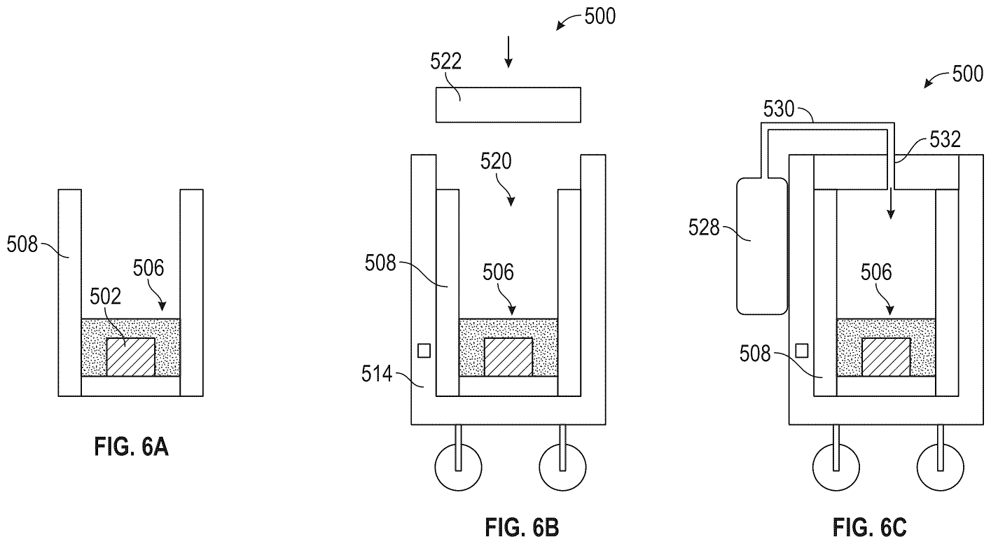

FIGS. 6A-6C are partially schematic illustrations of a method for loading an additively manufactured object 502 into the transport device 500, in accordance with embodiments of the present technology. Referring first to FIG. 6A, the object 502 can be embedded within a powder cake 506 and positioned within a build container 508, as described herein. The build container 508 can be open at the top such that when the build container 508 is removed from the additive manufacturing system, the powder cake 506 is briefly exposed to ambient air, which may not cause significant issues if as the build container 508 is transferred quickly into the transport device 500. Alternatively, a heavy inert gas such as argon or helium can be introduced into the build container 508 before the build container 508 is removed from the additive manufacturing system. The heavy inert gas can form a barrier over the powder cake 506 that is not substantially displaced by the ambient air, thus protecting the powder cake 506 during the transfer process.

Referring next to FIG. 6B, the build container 508 can be placed into the housing 514 of the transport device 500, and the lid 522 can be placed over the opening 520 to seal the build container 508 inside. Optionally, the lid 522 can be used as a compaction mechanism to apply pressure to the powder cake 506 to inhibit movement and/or deformation of the powder cake 506 during transportation.

Referring next to FIG. 6C, the reservoir 528 can then be used to introduce an inert gas into the empty space within the build container 508 via the fluid line 530 and port 532 to purge out any ambient air that is present and create an inert atmosphere.

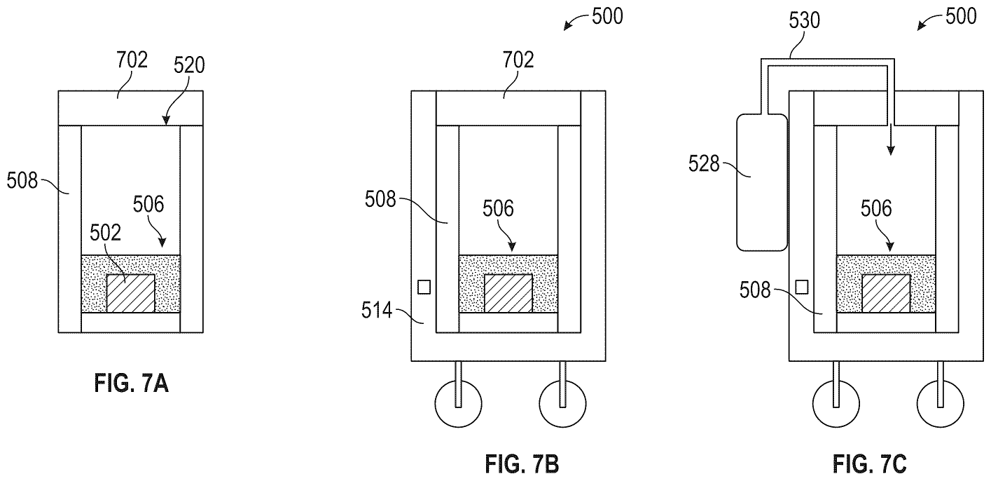

FIGS. 7A-7C are partially schematic illustrations of another method for loading an additively manufactured object 502 into the transport device 500, in accordance with embodiments of the present technology. Referring first to FIG. 7A, the object 502 can be embedded within a powder cake 506 and positioned within a build container 508, as described herein. The build container 508 can include an opening that is sealed with a lid 702 before or shortly after the build container 508 is removed from the additive manufacturing system to isolate the powder cake 506 from ambient air. The lid 702 can be part of the build container 508, or can be a separate component that is coupled to the build container 508. The lid 702 and/or build container 508 can include a locking mechanism to secure the lid 702 to the build container 508, such as magnets, latches, snap fit elements, etc.

In some embodiments, the lid 702 is placed over the opening 520 of the build container 508 while the build container 508 is still within the additive manufacturing system. The sealed build container 508 can then be removed from the additive manufacturing system for transfer to the transport device 500. The build container 508 can be filled with a heavy inert gas before the build container 508 is sealed with the lid 702, to further protect the powder cake 506 from oxygen in the ambient air. Optionally, the lid 702 can be used as a compaction mechanism to apply pressure to the powder cake 506 to inhibit movement and/or deformation of the powder cake 506 during transportation.

Referring next to FIG. 7B, the build container 508 can be placed into the housing 514 of the transport device 500. The transport device 500 may include a separate lid 522 (not shown) that can be used to enclose the build container 508 within the housing 514, or the lid 522 may be omitted.

Referring next to FIG. 7C, the reservoir 528 can then be used to introduce an inert gas into the empty space within the build container 508 to purge out any ambient air that is present and create an inert atmosphere. The lid 702 of the build container 508 can include a port that fluidically connects to the fluid line 530 of the reservoir 528, similar to the lid 522. In other embodiments, however, the reservoir 528 and purge process may be omitted.

The embodiments of the transport device 500 and corresponding methods illustrated in FIGS. 5-7C can be modified in many ways. For instance, some of the components shown in FIG. 5 can be omitted, such as the wheels 526, reservoir 528, fluid line 530, port 532, lid 522, and/or sensor 534. Moreover, the transport device 500 can include other components not shown in FIG. 5, such as additional chambers for receiving additional build containers 508.

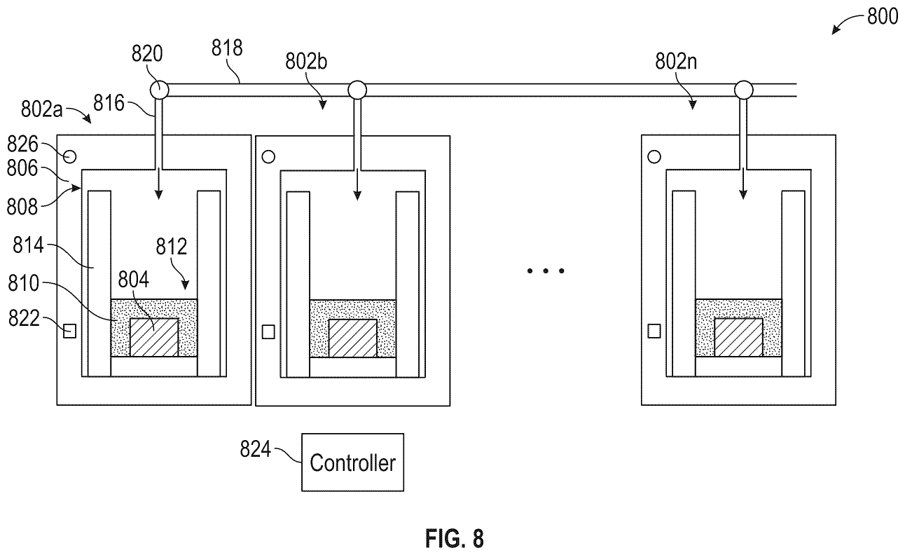

FIG. 8 is a partially schematic illustration of a cooling system 800 configured in accordance with embodiments of the present technology. The cooling system 800 can be used as the cooling system 406 of FIG. 4 and/or can include any of the features of the cooling system 406.

The cooling system 800 can be a cabinet, rack, or other similar structure having a plurality of compartments 802a-802n (collectively, “compartments 802”) for receiving and cooling one or more additively manufactured objects 804. Although FIG. 8 illustrates three compartments 802, the cooling system 800 can include any suitable number of compartments 802, such as one, two, five, 10, 20, 50, or more compartments 802. The compartments 802 can be arranged in a horizontal row as shown in FIG. 8, can be arranged in a vertical column, can be arranged in an array composed of a plurality of horizontal rows and a plurality of vertical columns, or any other suitable configuration.

Each compartment 802 can include a plurality of walls 806 defining an interior chamber 808 for receiving and cooling a respective set of additively manufactured objects 804 to a target temperature. Although the illustrated embodiment shows a single object 804 within each compartment 802, any of the compartments 802 can hold any suitable number of objects 804, such as two, three, four, five, 10, 20, 50, or more objects 804. Optionally, some or all of the compartments 802 can have different sizes to accommodate different numbers of objects 804.

As shown in FIG. 8, the object 804 can be embedded within a mass of precursor material 810 (collectively, “powder cake 812”). For instance, the object 804 can be fabricated via SLS or other powder bed fusion process, and the precursor material 810 can be a powder. However, in other embodiments, the object 804 can be present without any precursor material 810. The powder cake 812 can be provided within a build container 814, which can be identical or generally similar to the build container 508 of FIG. 5. For example, the build container 814 can be a bin, tank, vat, frame, etc., including a bottom wall (e.g., which may serve as the build platform for the object 804), a plurality of sidewalls, and an upper opening. The build container 814 can be a standard component of the additive manufacturing system that is used to hold the powder cake 812 during fabrication and the cooling process.

The chamber 808 of each compartment 802 can be configured to receive and enclose a build container 814. The compartment 802 can include a door (not shown) providing access to the chamber 808, which may be located at a sidewall of the compartment 802, at a top portion of the compartment 802, or at a bottom portion of the compartment 802. The door can be manually operated or can be coupled to an actuator (e.g., a piston, hydraulics) for automated operation. Optionally, the compartment 802 can include a set of guide structures (e.g., rails) to facilitate sliding of the build container 814 into and out of the chamber 808.

In some embodiments, the compartment 802 is configured to isolate the powder cake 812 from the surrounding environment in order to avoid exposing the powder cake 812 to reactive gases in the ambient air (e.g., oxygen) that may detrimentally affect the object 804 and/or precursor material 810. Thus, the door can include one or more gaskets that seal against the walls 806 of the compartment 802 so that the chamber 808 enclosing the build container 814 is fluidically sealed from the external environment. Each compartment 802 can include a port 816 that is configured to be fluidically connected to a source of an inert gas (e.g., nitrogen, argon, helium) via a fluid line 818 (e.g., a tube, pipe, or other connector). Although the port 816 is depicted as being in the top portion of the compartment 802, the compartment 802 can alternatively or additionally include one or more ports 816 at other locations, such as in the sidewall, the bottom portion, and/or the door of the compartment 802. The flow of gas into the compartment 802 can be controlled via one or more valves 820, such that the atmosphere within each compartment 802 can be controlled individually. Although FIG. 8 depicts all the compartments 802 being connected to the same fluid line 818, in other embodiments, some or all of the compartments 802 can be connected to the source of inert gas via different fluid lines 818, or can be connected to different sources of inert gases. Optionally, the compartment 802 can include one or more one-way valves (not shown) that allow any air that is initially within the chamber 808 to be purged by the introduction of the inert gas while also preventing the entry of external air.

The powder cake 812 can be allowed to cool inside the compartment 802 to a target temperature, such as a temperature less than or equal to 100° C., 90° C., 80° C., 70° C., 60° C., 50° C., 30° C., or 25° C. The cooling process can take at least 1 hour, 2 hours, 4 hours, 8 hours, 10 hours, 12 hours, or 24 hours. In some embodiments, the compartment 802 is configured to control the cooling rate of the powder cake 812, such as to a rate less than or equal to 10° C./min, 5° C./min, 2° C./min, 1° C./min, 0.5° C./min, or 0.1° C./min. The cooling rate can be sufficiently slow to reduce or prevent deformation, shrinkage, and/or other undesirable changes to the properties of the object 804. Cooling of the powder cake 812 can occur passively, or the compartment 802 can include active temperature control elements to expedite cooling, as described further below.

In some embodiments, the compartment 802 thermally isolates the build container 814 (and thus, the powder cake 812) from the surrounding environment and neighboring compartments 802 in order to control the cooling rate of the powder cake 812. For instance, the walls 806 and/or door of the compartment 802 can be made partially or entirely from one or more thermally insulative materials, and/or can be partially or entirely coated with one or more thermally insulative materials. Examples of thermally insulative materials that can be used include foams (e.g., polystyrene foam, urethane foam), fiberglass, mineral wool, cellulose-based materials, and combinations thereof.

Alternatively or in combination, the compartment 802 can include one or more active temperature control elements (not shown), such as one or more heating devices (e.g., heat sinks, heating plates, heat lamps, heated fluid) and/or one or more cooling devices (e.g., thermoelectric coolers, cold plates, cooled fluid). For instance, heating can be applied if the powder cake 812 is cooling too fast, while cooling can be applied if the powder cake 812 is cooling too slowly. Each compartment 802 can include a respective set of active temperature control elements, such that the temperature and cooling rate of each compartment 802 can be individually controlled. The active temperature control elements can be located at any suitable portion of the compartment 802, such as on an interior surface of one or more walls 806, on an exterior surface of one or more walls 806, within one or more walls 806, on an interior surface of the door, on an exterior surface of the door, within the door, or a suitable combination thereof. Optionally, the inert gas can be heated and/or cooled to serve as an active temperature control element.

In some embodiments, each compartment 802 includes one or more sensors 822 to monitor the operation of the compartment 802 and/or provide feedback for controlling the operation of the compartment 802. For example, the sensor 822 can be configured to detect whether the build container 814 is present within the compartment 802. In such embodiments, the sensor 822 can be a weight sensor that detects the presence of the build container 814 based on weight. The weight data produced by the weight sensor can optionally be used to adjust the operation of the compartment 802 (e.g., a lower weight may correspond to a smaller powder cake 812, and thus more inert gas may be needed to fill the larger empty space within the compartment 802; the cooling rate of the powder cake 812 may vary depending on its size, and the operation of the active temperature control elements may be varied accordingly). As another example, the sensor 822 can be a switch that is triggered when the build container 814 is loaded into the compartment 802, such as a mechanical, pressure-activated switch, etc.

As another example, the sensor 822 can be a temperature sensor, such a thermistor, a thermocouple, or an infrared sensor. The temperature sensor can measure the temperature of the powder cake 812 indirectly (e.g., by measuring the temperature within the chamber 808) or directly (e.g., measuring the surface temperature of the powder cake 812 using an infrared sensor, and/or measuring the interior temperature of the powder cake 812 using a temperature probe that is inserted into the powder cake 812).

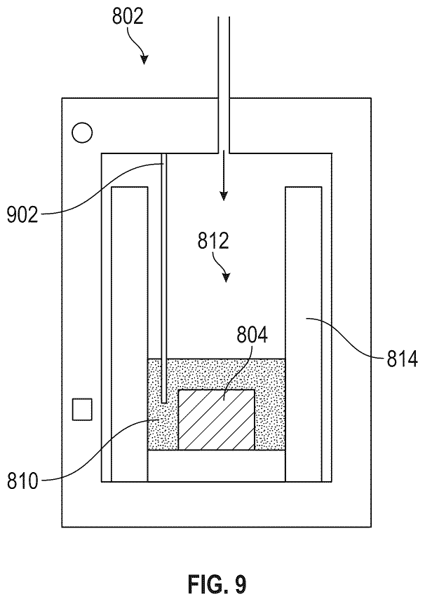

FIG. 9 is a partially schematic illustration of a temperature probe 902 for measuring the temperature of a powder cake 812 within a compartment 802 of the cooling system 800, in accordance with embodiments of the present technology. As shown in FIG. 9, the temperature probe 902 is an elongate temperature sensing device (e.g., a probe-type thermocouple) that can be inserted into the build container 814 and the powder cake 812 to monitor the internal temperature of the powder cake 812. This configuration may provide more accurate temperature measurements compared to surface temperature measurements and/or indirect temperature measurements.

In some embodiments, the temperature probe 902 is initially in a raised configuration, and is moved into a lowered configuration once the build container 814 has been placed into the compartment 802. Optionally, the distance that the temperature probe 902 is lowered before making contact with the powder cake 812 can be used to estimate the height of the powder cake 812, which in turn can be used to adjust the cooling of the powder cake 812 (e.g., a taller powder cake 812 can have a larger volume and thus may take longer to cool).

Referring again to FIG. 8, the temperature data produced by the temperature sensor can be used to control the operation of the compartment 802, such as by adjusting the heating and/or cooling provided by the active temperature control elements so that the powder cake 812 cools according to a target cooling profile, as described further below. Alternatively or in combination, the temperature sensor can be used to detect whether the powder cake 812 has cooled to the target temperature. The compartment 802 can generate a notification signal upon completion of cooling, such as by turning on an indicator light 826, transmitting a signal to another device, etc.

Other types of sensors 822 that can be included in the compartment 802 include optical sensors, distance sensors, force sensors, pressure sensors, strain sensors, motion sensors, or position sensors, or suitable combinations thereof.

Although the sensor 822 is depicted as being embedded within a wall 806 of the compartment 802, the sensor 822 can also be positioned at other locations of the compartment 802, such as on an interior surface of one or more walls 806, on an exterior surface of one or more walls 806, on an interior surface of the door, on an exterior surface of the door, within the door, within the chamber 808, or a suitable combination thereof. Moreover, although FIG. 8 depicts a single sensor 822, the compartment 802 can alternatively include a plurality of sensors 822, such as two, three, four, five, or more sensors 822. Some or all of the sensors 822 can be positioned at the same location, or some or all of the sensors 822 can be positioned at different locations. Some or all of the sensors 822 can be the same sensor type, or some or all of the sensor 822 can be different sensor types. Each compartment 802 can include a respective set of sensors 822 to allow for individualized monitoring of each compartment 802.

In some embodiments, the cooling system 800 includes a controller 824 to monitor and/or control the operation of the compartments 802. The controller 824 can be or include a computing device including one or more processors and memory storing instructions for performing the operations described herein. For example, the controller can perform some or all of the following operations: opening and closing the door of a compartment 802, monitoring loading of the build container 814 into a compartment 802, initiating a purge of air within a compartment 802, controlling the flow rate of the inert gas into a compartment 802, monitoring the pressure within a compartment 802 via one or more sensors 822, monitoring the temperature within a compartment 802 via one or more sensors 822, monitoring the temperature of the powder cake 812 with a compartment 802 via one or more sensors 822, monitoring a cooling rate of the powder cake 812 within a compartment 802 via one or more sensors 822, controlling the operation of one or more active temperature control elements based on sensor feedback, generating a notification signal that cooling of the powder cake 812 is complete, and/or generating alerts to notify an operator of error conditions (e.g., excessive temperature fluctuations, loss of pressure within a compartment 802 indicative of a leak).

The controller 824 can be configured to ensure that the powder cake 812 within each compartment 802 cools according to a target cooling profile. The target cooling profile can be defined by one or more parameters, such as a minimum cooling rate, a maximum cooling rate, a target cooling rate, a minimum cooling time, a maximum cooling time, and/or a target cooling time. In some embodiments, the cooling profile includes cooling the powder cake 812 at a substantially constant cooling rate throughout the entire cooling period. In other embodiments, the cooling profile can include cooling the powder cake 812 at different cooling rates throughout the cooling period, e.g., at a first cooling rate for a first time period, a second cooling rate for a second time period, etc. As described herein, the controller 824 can monitor and adjust the cooling status of the powder cake 812 based on feedback from one or more sensors 822. For instance, if the current cooling rate of the powder cake 812 exceeds the target and/or maximum cooling rate specified by the cooling profile, the controller 824 can use increase the amount of active heating and/or decrease the amount of active cooling applied to the powder cake 812. Alternatively, if the current cooling rate of the powder cake 812 is below the target and/or minimum cooling rate specified by the cooling profile, the controller 824 can use increase the amount of active cooling and/or decrease the amount of active heating applied to the powder cake 812.

The cooling profile can be customized based on the characteristics of the powder cake 812 and/or the objects 804, such as the size (e.g., volume, weight, surface area) of the powder cake 812, the type of precursor material 810 of the powder cake 812, the number of objects 804 within the powder cake 812, the type of objects 804 within the powder cake 812, the desired degree of dimensional accuracy for the objects 804, etc. In some embodiments, the controller 824 is configured to detect the characteristics of the powder cake 812 and/or objects 804, and to select an appropriate cooling profile based on the detected characteristics. For instance, the controller 824 can detect the characteristics based on data from one or more sensors 822, such as a weight sensor, a scanner or other device that reads the characteristics from a tag coupled to the build container 814 (e.g., an RFID tag), or suitable combinations thereof. Alternatively, the appropriate cooling profile can be manually selected by the operator.

The embodiment of the cooling system 800 illustrated in FIG. 8 can be modified in many ways. For instance, some of the components shown in FIG. 8 can be omitted, such as the sensor 822 and/or light 826. Moreover, the cooling system 800 can include other components not shown in FIG. 8. In some embodiments, for example, each compartment 802 includes a user interface (e.g., a touchscreen display) that shows information regarding the type of objects 804 present within the compartment 802, the number of objects 804 present, the cooling status of the objects 804, and/or any other relevant information. Alternatively or in combination, the user interface can display an identifier (e.g., a QR code, bar code) that can be read by a scanner to retrieve the object information. Optionally, the identifier can be formed in the top layer of the powder cake 812 during the additive manufacturing process, such that the powder cake 812 itself can be scanned to retrieve the object information.

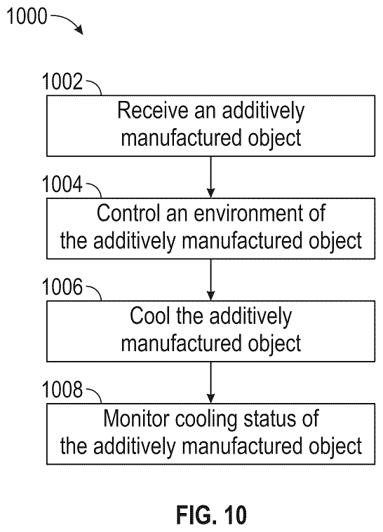

FIG. 10 is a flow diagram illustrating a method 1000 for processing an additively manufactured object, in accordance with embodiments of the present technology. The method 1000 can be performed by any of the systems and devices described herein, such as any of the embodiments of FIGS. 4-9. In some embodiments, some or all of the processes of the method 1000 are implemented as computer-readable instructions (e.g., program code) that are configured to be executed by one or more processors of a computing device, such as a controller (e.g., a controller of the system 400 of FIG. 4, a controller of the transport device 500 of FIG. 5, and/or the controller 824 of the cooling system 800 of FIG. 8).

The method 1000 can begin at block 1002 with receiving an additively manufactured object. For example, the object can be a dental appliance, such as an aligner, palatal expander, retainer, mouth guard, etc., as described further in Section II below. The object can be fabricated using any of the additive manufacturing processes disclosed herein. For example, the object can be fabricated from a powder (e.g., polymeric powder) using a powder bed fusion process, such as the SLS process described above in connection with FIG. 2, and can be embedded in a powder cake that is produced from the powder bed fusion process. In some embodiments, the process of block 1002 involves receiving a build container holding the additively manufactured object and, optionally, precursor material surrounding the object. The build container can be transferred from the additive manufacturing system to a transport device (e.g., the transport device 404 of FIG. 4 and/or the transport device 500 of FIG. 5), which can be used to transfer the build container to a cooling system (e.g., the cooling system 406 of FIG. 4 and/or the cooling system 800 of FIG. 8). Alternatively, the build container can be transferred directly to the cooling system without using a transport device.

At block 1004, the method 1000 can include controlling an environment of the additively manufactured object. The environment can be controlled while the object is in the transport device, while the object is in the cooling system, or both. In some embodiments, the process of block 1004 involves controlling the atmosphere surrounding the object and/or a precursor material (e.g., powder) surrounding the object. For instance, the process of block 1004 can include introducing at least one inert gas (e.g., nitrogen, argon, helium) into a space surrounding the object and/or precursor material. Alternatively or in combination, the process of block 1004 can include removing at least one reactive gas (e.g., oxygen) from the space surrounding the object and/or precursor material. The process of block 1004 can involve placing the build container holding the object and/or precursor material into an enclosed chamber of a transport device or cooling system, then introducing an inert gas into the chamber to purge out any reactive gases and/or prevent entry of external air into the chamber.

At block 1006, the method 1000 can include cooling the additively manufactured object. The cooling can be performed while the object is in the transport device, while the object is in the cooling system, or both. In some embodiments, the process of block 1006 involves placing the build container holding the object and/or precursor material into a chamber of the transport device or cooling system for a period of time sufficient for the object and/or precursor material to cool to a target temperature. For instance, the target temperature can be a temperature less than or equal to 100° C., 90° C., 80° C., 70° C., 60° C., 50° C., 30° C., or 25° C., and the cooling time period can be at least 1 hour, 2 hours, 4 hours, 8 hours, 10 hours, 12 hours, or 24 hours.

The object and/or precursor material can be cooled at a cooling rate that is sufficiently slow to reduce or prevent deformation, shrinkage, and/or other undesirable changes to the properties of the object. For instance, the cooling rate can be less than or equal to 10° C./min, 5° C./min, 2° C./min, 1° C./min, 0.5° C./min, or 0.1° C./min. In some embodiments, the chamber is thermally insulated from the surrounding environment in order to control the cooling rate of the object and/or precursor material. The process of block 1006 can involve passively cooling the object and/or precursor material, or can involve actively cooling the object and/or precursor material via one or more cooling devices (e.g., thermoelectric coolers, cold plates, cooled fluid). Optionally, one or more heating devices (e.g., heat sinks, heating plates, heat lamps, heated fluid) can be used to control the cooling rate of the object and/or precursor material, and/or to prevent the object and/or precursor material from being cooled below the target temperature.

At block 1008, the method 1000 can include monitoring a cooling status of the additively manufactured object. The cooling status can include the temperature and/or cooling rate of the object. Optionally, the cooling status can include the temperature and/or cooling rate of the precursor material. The cooling status can be measured using one or more temperature sensors, such as thermistors, thermocouples, infrared sensors, etc. The cooling status can be measured indirectly, such as by measuring the temperature within the chamber containing the object and/or precursor material. Alternatively or in combination, the cooling status can be measured directly, such as via a temperature sensor that is in direct contact with the object and/or precursor material. The cooling status can be monitored continuously or at suitable time intervals (e.g., once every 30 second, 1 minute, 2 minutes, 5 minutes, 10 minutes, etc.).

In some embodiments, the cooling status is used to provide notifications to an operator, such whether the object has reached the target temperature, estimated remaining time for the object to reach the target temperature, whether the object is cooling too slow or too fast, etc. The cooling status can optionally be used as feedback to control the operation of one or more active temperature control elements to ensure that the object cools according to a target cooling profile. For instance, if the cooling rate of the object exceeds a target and/or maximum cooling rate, active heating can be used to reduce the cooling rate of the object. Conversely, if the cooling rate of the object is below the target and/or minimum cooling rate, active cooling can be used to increase the cooling rate of the object.

The method 1000 illustrated in FIG. 10 can be modified in many different ways. For example, although the above processes of the method 1000 are described with respect to a single object, the method 1000 can be used to sequentially or concurrently fabricate and post-process any suitable number of objects, such as tens, hundreds, or thousands of additively manufactured objects. As another example, the ordering of the processes shown in FIG. 10 can be varied. Some of the processes of the method 1000 can be omitted and/or the method 1000 can include additional processes not shown in FIG. 10.

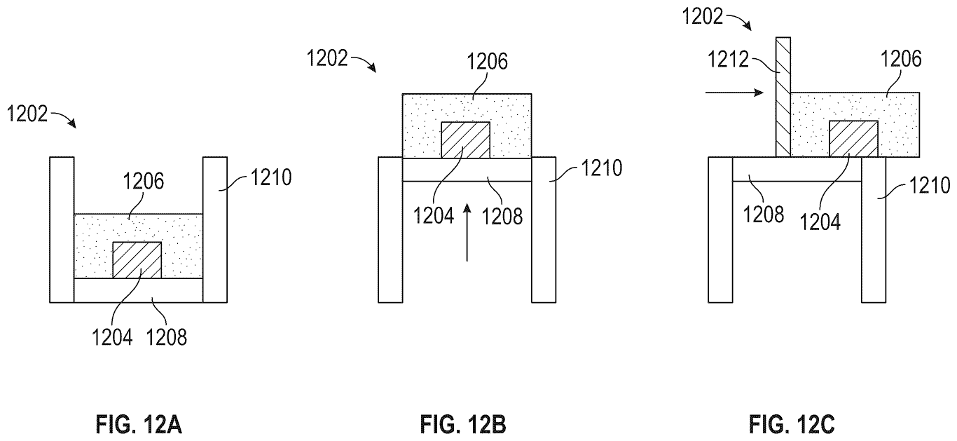

FIGS. 11-17 illustrate systems, devices, and methods for cleaning additively manufactured objects, in accordance with embodiments of the present technology. Specifically, FIG. 11 is a schematic diagram providing a general overview of a system 1100 for cleaning additively manufactured objects, and FIGS. 12A-17 illustrate processes and devices that can be incorporated into the system 1100. Although certain aspects of FIGS. 11-17 are described in connection with additively manufactured objects fabricated from a powder, these embodiments can be adapted for use with objects fabricated from other types of precursor materials and/or other additive manufacturing processes.

Referring first to FIG. 11, the system 1100 can be used to clean many different types of additively manufactured objects, such as dental appliances fabricated from a polymeric powder via a SLS or other powder bed fusion process. The system 1100 includes a housing 1102 (e.g., a case, sheath, or other enclosure) containing a plurality of process stations, such as an intake station 1104, a first cleaning station 1106, a recycling station 1108, a second cleaning station 1110, a waste station 1112, and/or a collection station 1114. The housing 1102 can be sealed (e.g., hermetically sealed) so that loose powder produced by the operation of the stations 1104-1114 does not escape into the surrounding environment. Optionally, the housing 1102 can have anti-static properties (e.g., be made partially or entirely out of an anti-static material) and/or be electrically grounded to reduce the risk of powder explosion due to electrostatic discharge.

The intake station 1104 is configured to receive one or more additively manufactured objects to be cleaned. The additively manufactured objects can be partially or fully covered by a precursor material (e.g., a powder) to be removed before further post-processing and/or use of the objects. For example, the objects can be received as part of a larger powder cake, as previously described with respect to FIG. 2B. Alternatively, the objects can be received as discrete parts that are not embedded in a larger component. In some embodiments, the intake station 1104 receives a single object at a time, while in other embodiments, the intake station 1104 receives multiple objects simultaneously (e.g., two, three, four, five, 10, 20, 50, or 100 objects).

The intake station 1104 can be positioned proximate to a door, hatch, lid, or other opening in the housing 1102 (not shown) that allows the objects to be transferred into the housing 1102 (e.g., manually by a human operator or automatically by a robotic assembly, conveyor belt, or other transport mechanism) and loaded into the intake station 1104. The objects can be loaded into the intake station 1104 on the build platform used to support the objects during additive manufacturing, on another device (e.g., a tray or container), or can be provided without any supporting device (e.g., the objects can be placed or poured directly into the intake station 1104). The intake station 1104 can include a tray, frame, container, or other component suitable for receiving and supporting the objects (and/or the device supporting the objects).

The intake station 1104 can then transfer the received objects to the next process station in the system 1100, such as the first cleaning station 1106. In some embodiments, the intake station 1104 initiates the transfer in response to an input from an operator indicating that the objects are loaded into the intake station 1104 and are ready for processing. The input can be received from a user interface device of the system 1100, such as a keyboard, touchscreen, button, etc. Optionally, the transfer can be initiated automatically in response to sensor data from one or more sensors indicating that the objects have been loaded in the intake station 1104. For example, the intake station 1104 can include a weight sensor that detects whether the objects have been loaded based on changes in weight. As another example, the intake station 1104 can include an imaging device (e.g., camera) that generates image data that can be analyzed to detect the presence of the objects. In a further example, the intake station 1104 can include mechanical switches that are triggered when the objects are loaded in the intake station 1104. Other types of sensors that can be used include, but are not limited to, any of the following: optical sensors, distance sensors, force sensors, pressure sensors, strain sensors, motion sensors, or position sensors, or suitable combinations thereof.

The transfer can be performed using any suitable technique, such as by pushing the objects to a target location using a blade, plate, piston, etc.; picking up the objects using a robotic arm, pick and place mechanism, etc., and placing the objects at the target location; transporting the objects to the target location using moving belts, rollers, tracks, etc.; pouring the objects into or onto the target location with aid of gravity; using pipes and a vacuum pump to transport the objects to the target location via suction; or suitable combinations thereof. The transfer can be performed in an automated manner such that little or no manual intervention is involved.

For example, FIGS. 12A-12C are partially schematic illustrations of a transfer process that can be performed by the intake station 1104, in accordance with embodiments of the present technology. Referring first to FIG. 12A, the intake station 1104 can receive a powder cake 1202 containing one or more additively manufactured objects 1204 partially or fully surrounded by a powder 1206. The powder cake 1202 can be positioned on a build platform 1208, which can be the same platform used to support the object 1204 and powder 1206 during additive manufacturing. The build platform 1208 can be positioned within a container 1210 (e.g., a bin, tank, exchange frame). The container 1210 can be a standard component of the additive manufacturing system that can be removed from the additive manufacturing system and placed directly into the intake station 1104.

Referring next to FIG. 12B, once the container 1210 is loaded in the intake station 1104, the intake station 1104 can include an actuator (not shown) that engages and raises the build platform 1208 upward relative to the container 1210. The top of the container 1210 can be open such that the powder cake 1202 can be raised partially or entirely out of the container 1210.

Referring next to FIG. 12C, the intake station 1104 can include a pusher 1212 (e.g., a blade, plate, piston, brush) that sweeps the powder cake 1202 off the build platform 1208 and into the next process station (e.g., into a cleaning station—not shown). In some embodiments, the intake station 1104 is positioned above the next process station so that the powder cake 1202 falls into the next process station by gravity. Optionally, the powder cake 1202 can be swept into or onto a chute, pipe, moving belt, rollers, tracks, or other conveyor positioned between the intake station 1104 and next process station, and the conveyor can transport the powder cake 1202 to the next process station.

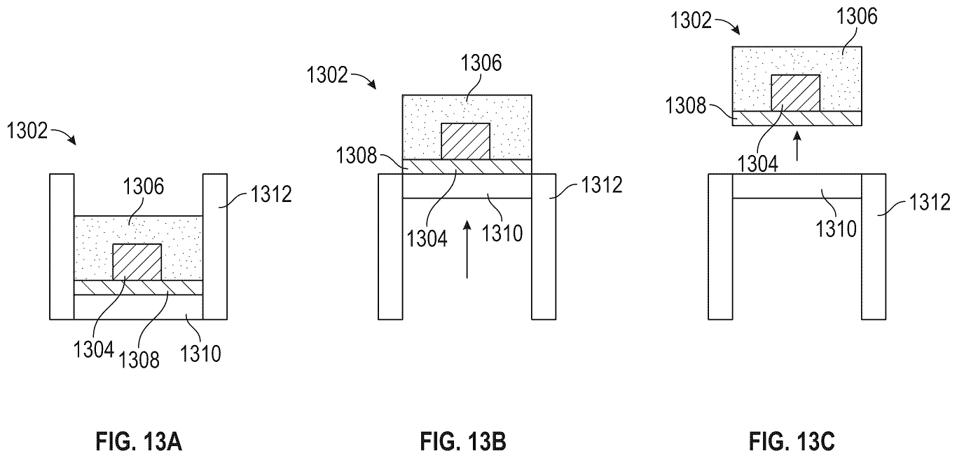

FIGS. 13A-13C are partially schematic illustrations of another transfer process that can be performed by the intake station 1104, in accordance with embodiments of the present technology. Referring first to FIG. 13A, the intake station 1104 can receive a powder cake 1302 containing one or more additively manufactured objects 1304 partially or fully surrounded by a powder 1306. The powder cake 1302 can be positioned on a removable tray 1308, which can be positioned on a build platform 1310 used to support the object 1304 and powder 1306 during additive manufacturing. Alternatively, the tray 1308 itself can serve as the build platform 1310 for additive manufacturing. The tray 1308 and/or build platform 1310 can be positioned within a container 1312 (e.g., a bin, tank, exchange frame). The container 1312 can be a standard component of the additive manufacturing system that can be removed from the additive manufacturing system and placed directly into the intake station 1104.

Referring next to FIG. 13B, once the container 1312 is loaded in the intake station 1104, the intake station 1104 can include an actuator (not shown) that engages and raises the tray 1308 and/or build platform 1310 upward relative to the container 1312. The top of the container 1312 can be open such that the powder cake 1302 can be raised partially or entirely out of the container 1312.

Referring next to FIG. 13C, the intake station 1104 can include a robotic assembly that removes the tray 1308 and powder cake 1302 from the container 1312, and places the tray 1308 and powder cake 1302 into the next process station (e.g., into a cleaning station—not shown). For example, the robotic assembly can include a gripper that mechanically engages the tray 1308, a magnetic element that interacts with one or more magnets in the tray 1308, a suction device that attaches to the tray 1308 via vacuum, etc. Optionally, the tray 1308 with the powder cake 1302 can be placed onto a moving belt, rollers, track, or other conveyor positioned between the intake station 1104 and next process station, and the conveyor can transport the tray 1308 and powder cake 1302 to the next process station.

Referring again to FIG. 11, in some embodiments, the one or more additively manufactured objects are transferred from the intake station 1104 to a first cleaning station 1106. The first cleaning station 1106 can utilize any suitable technique for cleaning at least some of the precursor material from the objects, such as by applying mechanical forces (e.g., vibration, centrifugation, tumbling, brushing), applying solvents (e.g., via spraying, immersion), heating or cooling, applying a vacuum, applying pressurized gases, or suitable combinations thereof. In some embodiments, for example, the first cleaning station includes a centrifuge station having a centrifuge that rotates the objects to remove at least some of the precursor material from the objects. For instance, in embodiments where the objects are initially embedded in a powder cake, the centrifugation can break apart the powder cake and separate the loose powder from the objects. The centrifugation can also remove other unwanted material that is present in the powder cake, such as debris (e.g., agglomerated powder, chunks, contaminants). Alternatively or in combination, the first cleaning station 1106 can include a vibratory cleaning station, such as a vibrating platform (e.g., a drum, table, tray) that uses physical vibration of the objects and precursor material to separate at least some of the precursor material from the objects. The first cleaning station 1106 can concurrently process any suitable number of objects, such as one, two, three, four, five, 10, 20, 50, 100, or more objects.

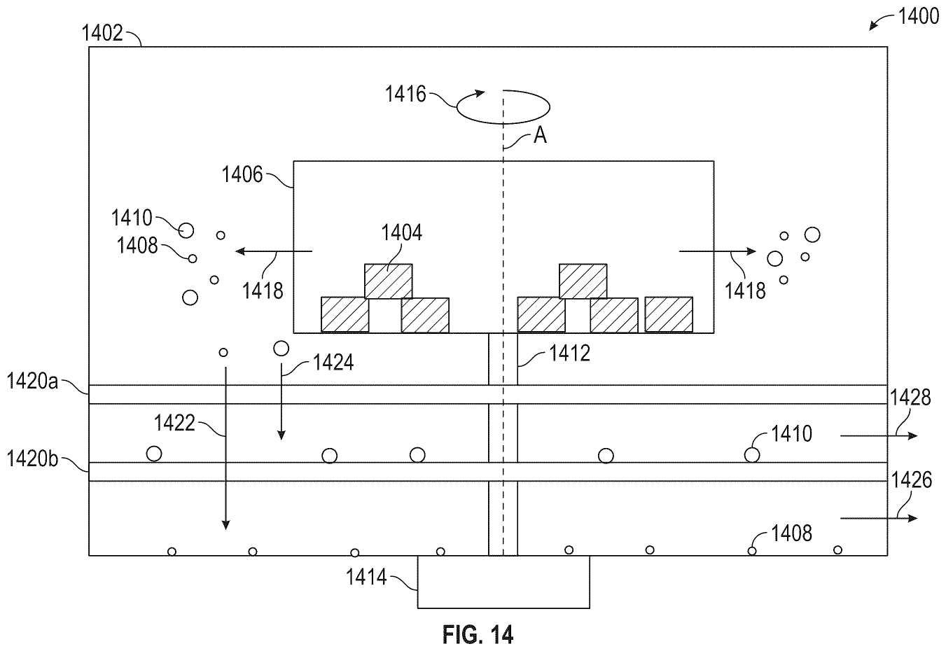

FIG. 14 is a partially schematic side view of a centrifuge 1400 that can be included in the first cleaning station 1106, in accordance with embodiments of the present technology. The centrifuge 1400 includes a housing 1402 (e.g., a case, sheath, or other enclosure) which can be sealed (e.g., hermetically sealed) so that loose powder produced by the operation of the centrifuge 1400 does not escape into the surrounding environment. Optionally, the housing 1402 can have anti-static properties (e.g., be made partially or entirely out of an anti-static material) and/or be electrically grounded to reduce the risk of powder explosion due to electrostatic discharge.

The housing 1402 can include an opening (e.g., door, hatch, lid—not shown) to allow one or more additively manufactured objects 1404 to be transferred into the centrifuge 1400 (e.g., from the intake station 1104 or a conveyor operably coupled to the intake station 1104). The opening can be positioned at any suitable location in the housing 1402, such as an upper wall or a side wall of the housing 1402, depending on the location of the centrifuge 1400 relative to the intake station 1104 and/or conveyor. For example, in embodiments where the objects 1404 are swept into the centrifuge 1400 as part of a powder cake (e.g., as illustrated in FIGS. 12A-12C), the centrifuge 1400 can be positioned below the intake station 1104 and the opening can be located in the upper wall of the housing 1402, such that the powder cake falls through the opening and into the centrifuge 1400 via gravity.

The centrifuge 1400 includes a receptacle 1406 (e.g., a basket, drum, bucket, or other container) configured to receive the objects 1404. The upper portion of the receptacle 1406 can be open to allow the objects 1404 to be placed into the receptacle 1406. The side walls and/or bottom wall of the receptacle 1406 can include a plurality of openings (e.g., pores, perforations, slots—not shown) that are sized to allow residual material (e.g., precursor material such as powder 1408, unwanted material such as debris 1410) to exit the receptacle 1406 while retaining the objects 1404 within the receptacle 1406. For example, the openings can be larger than the residual material but smaller than the objects 1404. In some embodiments, the openings have an average width and/or diameter that is less than or equal to 20 mm, 10 mm, 5 mm, 2 mm, 1 mm, 0.5 mm, or 0.1 mm.

The receptacle 1406 can be coupled to a rotor shaft 1412 and actuator 1414 (e.g., a motor) that rotates the receptacle 1406 around an axis of rotation A. The actuator 1414 can spin the receptacle 1406 in a clockwise direction, a counterclockwise direction, or both, as indicated by arrows 1416. The rotation of the receptacle 1406 can produce forces that remove residual material (e.g., powder 1408 and/or debris 1410) by driving the material away from the center of rotation, off the objects 1404, and out of the receptacle 1406 via the openings, as indicated by arrows 1418. In some embodiments, the rotation removes at least 50%, 60%, 70%, 80%, 90%, 95%, or 99% by weight of the residual material that was initially present on and/or around the objects 1404.

The centrifugation parameters (e.g., force, rotation speed, rotation direction, rotation time, ramp up time, ramp up rate, ramp down time, ramp down rate, environmental temperature) can be selected to efficiently remove residual material from the objects 1404 while avoiding damage to the objects 1404. Optionally, the centrifugation parameters can be configured to remove unadhered powder or loosely adhered powder that is suitable for reuse, while avoiding removal of more tightly adhered powder that may not be suitable for reuse (e.g., due to closer exposure to sintering energy that may cause degradation of the powder). The appropriate parameters can be determined based on the object type (e.g., type of dental appliance), material properties of the objects 1404, residual material type, residual material size (e.g., particle size), degree of adhesion between the residual material and the objects 1404, desired degree of cleaning, etc. For example, the centrifuge 1400 can produce forces of at least 50 g, 100 g, 150 g, 200 g, 250 g, 300 g, 350 g, 400 g, 450 g, or 500 g. The actuator 1414 can be configured to rotate at any rotation speed suitable for producing the desired force, such as at least 50 RPM, 100 RPM, 200 RPM, 300 RPM, 400 RPM, 500 RPM, or more. Optionally, several stators can be placed in the receptacle 1406 such that the stators remain stationary or have a relative motion with respect to the rest of the rotating elements. The relative motion may serve as a source of additional resistance to assist in depowdering.

The centrifuge 1400 can optionally be a vibratory centrifuge that vibrates the objects 1404 before, during, and/or after rotation to enhance removal of the residual material. In such embodiments, the actuator 1414 can also produce vibrations that are transmitted to the receptacle 1406 via the rotor shaft 1412, and/or the centrifuge 1400 can include a separate actuator that is coupled to the receptacle 1406 to produce the vibrations. The vibration parameters (e.g., vibration amplitude, vibration frequency, timing) can be selected to efficiently remove residual material from the objects 1404 while avoiding damage to the objects 1404. Optionally, the vibration parameters can be configured to remove unadhered or loosely adhered powder that is suitable for reuse, while avoiding removal of more tightly adhered powder that may not be suitable for reuse (e.g., due to closer exposure to sintering energy that may cause degradation of the powder). For example, the appropriate vibration parameters can be determined based on the object type (e.g., type of dental appliance), material properties of the objects 1404, residual material type, residual material size (e.g., particle size), degree of adhesion between the residual material and the objects 1404, desired degree of cleaning, etc.

In some embodiments, the centrifuge 1400 includes additional components to enhance cleaning of the objects 1404, in combination with rotating and/or vibrating the objects 1404. For instance, the centrifuge 1400 can include one or more temperature control elements (e.g., heating elements and/or cooling elements) to maintain the interior of the centrifuge 1400 at an appropriate temperature. In some embodiments, the centrifuge 1400 is maintained at a sufficiently low temperature to avoid warping of the objects 1404 and/or to offset heating caused by vibrations, such as room temperature (e.g., 25° C.) and/or a temperature below the glass transition temperature of the objects 1404. Examples of temperature control elements include, but are not limited to, heat sinks, heating plates, heat lamps, heated fluid, thermoelectric coolers, cold plates, cooled fluid, and suitable combinations thereof. The temperature control elements can be located within the housing 1402 of the centrifuge 1400, can be located outside but thermally coupled to the housing 1402 (e.g., a heating or cooling jacket attached to the exterior of the housing, a device that pumps heated or cooled fluid into the housing 1402), or any suitable combination thereof.

As another example, the centrifuge 1400 can include one or more nozzles that apply pressurized fluid to the objects 1404 within the receptacle 1406 to facilitate cleaning of the objects 1404. For example, the fluid can be compressed air or another compressed gas to blow residual material off the objects 1404. Alternatively or in combination, the fluid can be a wash fluid (e.g., water, solvent) to rinse the residual material from the objects 1404. Heated or cooled fluids can also be applied to the objects 1404 to heat or cool the objects 1404 to a desired temperature, respectively. The nozzles can be positioned at any suitable location within the housing 1402, such as at the upper wall, the bottom wall, and/or side walls of the housing 1402. The actuator 1414 can spin the receptacle 1406 and the objects 1404 while the fluid is applied from the nozzles, or the receptacle 1406 and the objects 1404 can remain stationary while the fluid is applied.

Optionally, the centrifuge 1400 can include one or more sensors configured to monitor the operational status of the centrifuge 1400 and/or the cleaning status of the objects 1404. In some embodiments, at least some of the sensors are configured to detect whether the objects 1404 have been loaded into the receptacles 1406 and the centrifuge 1400 automatically initiates the centrifugation process in response to detection of the objects 1404. For example, the receptacle 1406 can include or be coupled to a weight sensor that detects whether the objects 1404 have been loaded based on changes in weight. As another example, the centrifuge 1400 can include an imaging device (e.g., camera) that generates image data of the receptacle 1406 that can be analyzed to detect the presence of the objects 1404. In a further example, the centrifuge 1400 can include switches that are triggered when the objects 1404 are loaded in the receptacle 1406. For instance, in embodiments where the objects 1404 are loaded into the receptacle 1406 on a tray (e.g., the tray 1308 of FIGS. 13A-13C), the tray can include features that mate with features on the receptacle (e.g., mating sets of holes and pins) to trigger the switches. As yet another example, the centrifuge 1400 can include a pressure-activated contact switch that automatically activates when the objects 1404 are loaded into the receptacle 1406, similar to the activation mechanism of a vortex mixer. Other types of sensors that can be used include, but are not limited to, any of the following: optical sensors, distance sensors, force sensors, pressure sensors, strain sensors, motion sensors, or position sensors, or suitable combinations thereof. In other embodiments, the centrifuge 1400 can instead initiate the centrifugation process in response to input from an operator (e.g., input received from a user interface device such as a keyboard, touchscreen, button, etc.).

Alternatively or in combination, at least some of the sensors can be configured to monitor the cleaning status of the objects 1404. For example, the centrifuge 1400 can include an imaging device (e.g., camera) that generates image data of the objects 1404, and the image data can be analyzed to determine the amount of residual material remaining on the objects 1404 (e.g., using computer vision techniques and/or machine learning algorithms). This approach can be used in situations where the visual characteristics of the residual material (e.g., color, opacity, reflectivity) differ from the visual characteristics of the objects 1404. Optionally, the imaging device can image the objects 1404 using non-visible wavelengths (e.g., UV, infrared) if the visual contrast between the residual material and the objects 1404 is more visible at those wavelengths. As another example, the receptacle 1406 can include or be coupled to a weight sensor that detects the cleaning status of the objects 1404 based on changes in weight (e.g., the objects 1404 are considered to be sufficiently clean if the total weight is below a threshold value and/or is no longer decreasing over time). Other types of sensors that can be used include, but are not limited to, any of the following: optical sensors, distance sensors, force sensors, pressure sensors, strain sensors, motion sensors, position sensors, or switches, or suitable combinations thereof. The cleaning status determined from the sensor(s) can be used to control the operation of the centrifuge 1400, e.g., the centrifuge 1400 can stop rotating when the objects 1404 are sufficiently cleaned, the centrifuge 1400 can continue rotating and/or alter the centrifugation parameters if the objects 1404 are not sufficiently cleaned, etc.

Referring again to FIG. 11, in some embodiments, the precursor material removed from the one or more additively manufactured objects by the first cleaning station 1106 is reusable for subsequent additive manufacturing operations. For instance, powder that had little or no exposure to sintering energy can be combined with fresh powder and reused to fabricate other objects via SLS. Accordingly, the first cleaning station 1106 can be configured to collect the precursor material for transfer to a recycling station 1108.

For example, referring back to FIG. 14, the centrifuge 1400 can include one or more sieves 1420a, 1420b (collectively, “sieves 1420”) that filter the residual material removed from the objects 1404 to separate reusable precursor material from debris and/or other unwanted components that may be present. In the illustrated embodiment, the sieves 1420 are located at the bottom portion of the centrifuge 1400 below the receptacle 1406 such that residual material exiting the receptacle 1406 during centrifugation falls onto the sieves 1420 via gravity. The pore sizes of the sieves 1420 can be selected such that reusable precursor material passes through each of the sieves 1420 (e.g., powder 1408 travels to the bottom of the centrifuge 1400 as indicated by arrow 1422), while larger unwanted components are trapped (e.g., debris 1410 is trapped by sieve 1420b as indicated by arrow 1424). For instance, one or more of the sieves can have a pore size larger than the size of the powder 1408 but smaller than the size of the debris 1410. In embodiments where the centrifuge 1400 includes multiple sieves 1420, the sieves 1420 can be arranged in order of decreasing pore size to progressively filter out smaller particles. For instance, the sieve 1420a can have a larger pore size than the sieve 1420b. In other embodiments, however, the sieves 1420 can be arranged differently and/or the centrifuge 1400 can have a different number of sieves 1420 (e.g., a single sieve 1420 or more than two sieves 1420).

The centrifuge 1400 can be operably coupled to a vacuum pump (not shown) that collects the reusable precursor material that has passed through the sieves 1420 and transfers the material to the recycling station 1108, as indicated by arrow 1426. Optionally, the centrifuge 1400 can also be operably coupled to another vacuum pump (not shown) that collects the unwanted components trapped by the sieves 1420 and transfers the components to the waste station 1112, as indicated by arrow 1428. One or both of the vacuum pumps can be made of an anti-static material and/or be electrically grounded to reduce the risk of powder explosion, as described elsewhere herein. Alternatively or in combination, the centrifuge 1400 can use other techniques for collecting and transporting the reusable precursor material and/or unwanted components, such as sweeping, pouring, blowing, etc.

In some embodiments, the sieves 1420 are omitted, such that the sieving of the reusable precursor material occurs outside of the centrifuge 1400. For instance, the centrifuge 1400 can be operably coupled to a vacuum pump or other mechanism that collects all of the removed material and transports it to a separate location for sieving. In such embodiments, sieving can be performed at the recycling station 1108, and the unwanted components produced by the sieving process can be subsequently transferred from the recycling station 1108 to the waste station 1112 via pumping, sweeping, pouring, blowing, etc.

Referring again to FIG. 11, the recycling station 1108 can mix the reusable precursor material with fresh precursor material and/or perform other operations to prepare the precursor material for reuse (e.g., additional sieving, powder conditioning, quality control analysis). The recycling station 1108 can collect and store the reusable precursor material in a container within the housing 1102, or can transport the reusable precursor material to a location outside of the housing 1102 (e.g., via pumps, pipes, and/or other suitable devices). Moreover, although FIG. 11 illustrates the recycling station 1108 as being within the housing 1102, in other embodiments, the recycling station 1108 can be a separate component that is located outside of the housing 1102.

After cleaning, the one or more additively manufactured objects can be transferred from the first cleaning station 1106 to the second cleaning station 1110 (e.g., a brushing station) via a conveyor. The conveyor can use any suitable technique for transferring the objects, such as pushing the objects to a target location using a blade, plate, piston, etc.; picking up the objects using a robotic arm, pick and place mechanism, etc., and placing the objects at the target location; transporting the objects to the target location using moving belts, rollers, tracks, etc.; pouring the objects into or onto the target location with aid of gravity; using pipes and a vacuum pump to transport the objects to the target location via suction; or suitable combinations thereof. For example, the objects can be removed from the receptacle of the centrifuge and placed onto a moving belt or chute, and the moving belt or chute can be angled so that the objects fall into the second cleaning station 1110 at least partially due to gravity. The transfer can be performed in an automated manner such that little or no manual intervention is involved.

The second cleaning station 1110 can utilize any suitable technique for cleaning at least some of the precursor material from the objects, such as by applying mechanical forces (e.g., vibration, centrifugation, tumbling, brushing), applying solvents (e.g., via spraying, immersion), heating or cooling, applying a vacuum, applying pressurized gases, or suitable combinations thereof. The cleaning technique used by the second cleaning station 1110 can be the same as or different from the cleaning technique used by the first cleaning station 1106. In some embodiments, for example, the second cleaning station 1110 includes a brushing station having one or more brushes (e.g., flat brushes, rotary brushes, brush strips) that remove at least some of the precursor material from the objects via brushing. For example, brushing can be used to remove precursor material that has adhered to the surfaces of the object and/or otherwise remains on the object after centrifugation. The brushing can also remove other unwanted material that is present on the object, such as debris (e.g., agglomerated powder, chunks, contaminants). The second cleaning station 1110 can concurrently or sequentially process any suitable number of objects, such as one, two, three, four, five, 10, 20, 50, 100, or more objects.

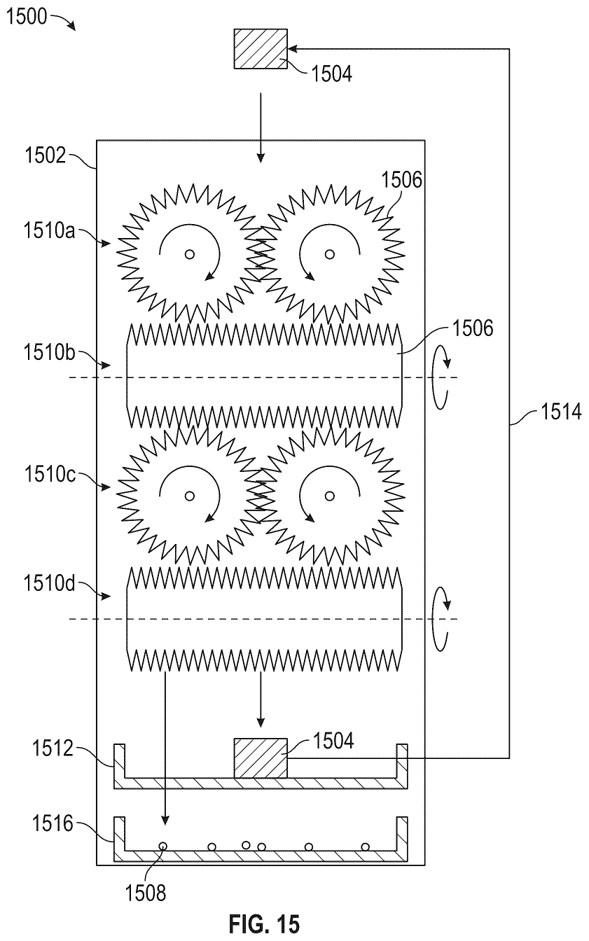

FIG. 15 is a partially schematic side view of a brush assembly 1500 that can be included in the second cleaning station 1110, in accordance with embodiments of the present technology. The brush assembly 1500 includes a housing 1502 (e.g., a case, sheath, or other enclosure) which can be sealed (e.g., hermetically sealed) so that loose powder produced by the operation of the brush assembly 1500 does not escape into the surrounding environment. Optionally, the housing 1502 can have anti-static properties (e.g., be made partially or entirely out of an anti-static material) and/or be electrically grounded to reduce risk of powder explosion due to electrostatic discharge.

The housing 1502 can include an opening (e.g., door, hatch, lid—not shown) to allow one or more additively manufactured objects 1504 to be transferred into the brush assembly 1500 (e.g., from the first cleaning station 1106 or a conveyor operably coupled to the first cleaning station 1106). The opening can be positioned at any suitable location in the housing 1502, such as an upper wall or a side wall of the housing 1502, depending on the location of the brush assembly 1500 relative to the first cleaning station 1106 and/or conveyor. For example, in embodiments where the objects 1504 are transported to the brush assembly 1500 via an angled belt or chute, the brush assembly 1500 can be positioned below the output end of the angled belt or chute, and the opening can be located in the upper wall of the housing 1502, such that the objects 1504 fall through the opening and into the brush assembly 1500 via gravity.

The brush assembly 1500 can include a series of rotary brushes 1506 within the housing 1502 that are configured to clean the objects 1504. Each rotary brush 1506 can have an elongate, cylindrical body and a plurality of brush features (e.g., fibers, bristles, fins) extending radially outward from the body. The brush features can be made out of any suitable material (e.g., synthetic polymers, natural materials, metals), depending on the material of the objects 1504, desired degree of cleaning, etc. The rotary brushes 1506 can each rotate around a respective axis of rotation in a clockwise direction, a counterclockwise direction, or both. As the objects 1504 pass by the rotary brushes 1506, the rotating brush features of the rotary brushes 1506 can contact the surfaces of the objects 1504 to apply brushing forces that remove residual material (e.g., precursor material such as powder 1508, and/or other unwanted components such as debris).

In the illustrated embodiment, the rotary brushes 1506 are arranged in a series of rotary brush pairs 1510a-1510d (collectively, “brush pairs 1510”). Although FIG. 15 illustrates four brush pairs 1510, in other embodiments, the brush assembly 1500 can include a different number of brush pairs 1510 (e.g., one, two, three, five, 10, 20, or more brush pairs 1510). Each brush pair 1510 can include a first rotary brush 1506 and a second rotary brush 1506 (brush pairs 1510b, 1510d are rotated 90° relative to brush pairs 1510a, 1510c so that only a single rotary brush 1506 of each of the brush pairs 1510b, 1510d is visible in FIG. 15). The first and second rotary brushes 1506 of each brush pair 1510 can be spaced apart by a separation distance that is sufficiently large to allow the objects 1504 to pass between the rotary brushes 1506, but sufficiently small so that the brush features of the first and second rotary brushes 1506 can contact the surfaces of the objects 1504. Optionally, the spacing between the first and second rotary brushes 1506 can be adjustable to accommodate different object sizes. In such embodiments, the first and/or second rotary brushes 1506 can be coupled to a linear actuator, mounted on a track, or otherwise movable relative to each other to increase or decrease the separation distance. Some or all of the brush pairs 1510 can have the same separation distance, and/or some or all of the brush pairs 1510 can have different separation distances.

As shown in FIG. 15, the first and second rotary brushes 1506 of each brush pair 1510 can rotate in opposite directions and toward each other (e.g., the left rotary brush 1506 rotates clockwise and the right rotary brush 1506 rotates counterclockwise) to direct the objects 1504 downward through the space between the first and second rotary brushes 1506. In other embodiments, however, the first and second rotary brushes 1506 can rotate in opposite directions and away from each other, or can rotate in the same direction. Moreover, the rotation direction of the rotary brushes 1506 can change periodically during the operation of the brush assembly 1500. The rotation direction and/or speed of the rotary brushes 1506 can be selected to efficiently remove residual material from the objects 1504 while avoiding damage to the objects 1504, and can be selected based on the object type (e.g., type of dental appliance), material properties of the objects 1504, residual material type, residual material size (e.g., particle size), degree of adhesion between the residual material and the objects 1504, desired degree of cleaning, etc.

In some embodiments, the brush pairs 1510 are arranged in a vertical configuration, with each brush pair 1510 being located at a different vertical position within the housing. Accordingly, the objects 1504 can be brushed by multiple successive brush pairs 1510 as the objects 1504 pass through the brush assembly 1500, which can enhance cleaning efficacy. Additionally, the vertical configuration allows the objects 1504 to pass through each brush pair 1510 sequentially with aid of gravity. Although FIG. 15 illustrates a single brush pair 1510 at each vertical position, in other embodiments, the brush assembly 1500 can include two or more brush pairs 1510 at each vertical position, which can be advantageous for processing larger numbers of objects 1504 concurrently.

In the illustrated embodiment, some of the brush pairs 1510 are oriented in the same direction, and some of the brush pairs 1510 are oriented in different directions. As shown in FIG. 15, brush pairs 1510a, 1510c are oriented in a first direction (e.g., orthogonal to the page), and brush pairs 1510b, 1510d are oriented in a second, different direction (e.g., parallel to the page and orthogonal to brush pairs 1510a, 1510c). The first direction can be at any suitable angle relative to the second direction, such as an angle greater than or equal to 10°, 20°, 30°, 40°, 50°, 60°, 70°, 80°, or 90°. The use of brush pairs with different orientations can improve cleaning efficiency by exposing different portions of the objects 1504 to brushing. In other embodiments, the brush assembly 1500 can include any suitable combination of brush pairs 1510 oriented in the same or different directions, or all of the brush pairs 1510 can be oriented in the same direction or in different directions, etc.

Optionally, the brush assembly 1500 can include additional components to enhance cleaning of the objects 1504, in combination with brushing the objects 1504. For instance, the brush assembly 1500 can include one or more temperature control elements (e.g., heating elements and/or cooling elements) to maintain the interior of the housing 1502 at an appropriate temperature. In some embodiments, the interior of the housing 1502 is maintained at a sufficiently low temperature to avoid warping of the objects 1504 and/or to offset frictional heating caused by the brushing, such as room temperature (e.g., 25° C.) and/or a temperature below the glass transition temperature of the objects 1504. Examples of temperature control elements include, but are not limited to, heat sinks, heating plates, heat lamps, heated fluid, thermoelectric coolers, cold plates, cooled fluid, and suitable combinations thereof. The temperature control elements can be located within the housing 1502 of the brush assembly 1500, can be located outside but thermally coupled to the housing 1502 (e.g., a heating or cooling jacket attached to the exterior of the housing, a device that pumps heated or cooled fluid into the housing 1502), or any suitable combination thereof.

As another example, the brush assembly 1500 can include one or more nozzles that apply pressurized fluid to the objects 1504 to facilitate cleaning of the objects 1504. For example, the fluid can be compressed air or another compressed gas to blow material off the objects 1504. Alternatively or in combination, the fluid can be a wash fluid (e.g., water, solvent) to rinse the residual material from the objects 1504. Heated or cooled fluids can also be applied to the objects 1504 to heat or cool the objects 1504 to a desired temperature, respectively. The nozzles can be positioned at any suitable location within the housing 1502, such as at the upper wall, the bottom wall, and/or side walls of the housing 1502. Optionally, some or all of the nozzles can be incorporated into the rotary brushes 1506. The fluid can be applied to the objects 1504 before, during, and/or after brushing of the objects 1504 by the rotary brushes 1506.

Alternatively or in combination, the nozzles can apply pressurized fluid (e.g., compressed air) to some or all of the rotary brushes 1506 to clean removed material (e.g., powder 1508) from the rotary brushes 1506. This approach can be used in situations where the removed material may adhere to the brush features of the rotary brushes 1506, which may clog or otherwise reduce the cleaning efficacy of the rotary brushes 1506 over time. In such embodiments, the fluid can be applied to the rotary brushes 1506 continuously during operation of the brush assembly 1500, or can be applied at certain intervals (e.g., once every x minutes, after each batch of objects 1504, when sensor data indicates that the rotary brushes 1506 should be cleaned).

Upon exiting the lowermost brush pair 1510d, the objects 1504 can land in a first collector 1512 (e.g., a tray, basket, bucket, or other receptacle) positioned near the bottom of the housing 1502. The first collector 1512 can be a sieve including a plurality of openings (e.g., pores, perforations, slots—not shown) that allow removed material (e.g., powder 1508 and/or debris) to pass through while retaining the objects 1504. For instance, the size of openings can be larger than the size of the removed material but smaller than the size of the objects 1504. In some embodiments, the openings have an average width and/or diameter that is less than or equal to 20 mm, 10 mm, 5 mm, 2 mm, 1 mm, 0.5 mm, or 0.1 mm. The objects 1504 in the first collector 1512 can subsequently be transferred from the brush assembly 1500 to another process station (e.g., the collection station 1114 of FIG. 11), as described further below.

In some embodiments, the objects 1504 in the first collector 1512 are recirculated back to the upper portion of the brush assembly 1500 to be recleaned by the brush pairs 1510, as indicated by arrow 1514. Recirculation of the objects 1504 can be performed in various ways. For instance, the first collector 1512 containing the objects 1504 can be transported to the top of the housing 1502 (e.g., using a lift mechanism such as an elevator, robotic arm, moving belt, etc.). The objects 1504 can then be poured from the first collector 1512 and into the housing 1502, such that the objects 1504 pass through and are cleaned by the series of brush pairs 1510. Alternatively, the objects 1504 can be removed from the first collector 1512 before being transported back to the top of the housing 1502 and recirculated through the brush assembly 1500, e.g., using a robotic arm, pick and place mechanism, moving belts, roller, tracks, or other suitable device. The cleaning and recirculation process can be repeated multiple times (e.g., two, three, four, five, or more times) and/or until a satisfactory degree of cleaning is achieved. In other embodiments, however, the objects 1504 may pass through the brush assembly 1500 only once, without recirculation.

In some embodiments, the brush assembly 1500 includes or is operably coupled to a sampling mechanism that periodically collects one or more objects 1504 to check the cleaning status. For instance, objects 1504 can be sampled from the first collector 1512, from the upper portion of the brush assembly 1500 before entering the housing 1502, and/or any other suitable location in the brush assembly 1500. The sampled objects 1504 can be collected using a robotic arm, pick and place mechanism, pushers, moving belts, or any other suitable device, and transported to the sampling mechanism. The sampling mechanism can be located within the housing 1502 or can be at a separate location outside of the housing 1502.

The sampling mechanism can include one or more sensors that generate sensor data indicative of the cleaning status of the sampled objects 1504. For example, the sensor(s) can include an imaging device (e.g., camera) that generates image data of the objects 1504, and the image data can be analyzed to determine the amount of residual material remaining on the objects 1504 (e.g., using computer vision techniques and/or machine learning algorithms). This approach can be used in situations where the visual characteristics of the residual material (e.g., color, opacity, reflectivity) differ from the visual characteristics of the objects 1504. Optionally, the imaging device can image the objects 1504 using non-visible wavelengths (e.g., UV, infrared) if the visual contrast between the residual material and the objects 1504 is more visible at those wavelengths. As another example, the sampling mechanism can include sensors that measure surface roughness of the objects 1504 to evaluate the cleaning status (e.g., a lower surface roughness can correlate to a higher degree of cleaning). Other types of sensors include, but are not limited to, optical sensors, weight sensors, or suitable combinations thereof.

The cleaning status of the objects 1504 can be evaluated based on measurements over time, such as whether the rate of change of characteristics such as surface roughness is decreasing. The cleaning status can also be evaluated based on the number or percentage of sampled objects 1504 that are considered sufficiently cleaned, such as whether the “pass” rate has exceeded a threshold value. The cleaning status determined from the sensor(s) can subsequently be used to control the operation of the brush assembly 1500, e.g., the brush assembly 1500 can stop recirculating the objects 1504 once the objects 1504 are sufficiently cleaned, the brush assembly 1500 can continue recirculating the objects 1504 and/or adjust the operating parameters of the rotary brushes 1506 if the objects 1504 are not sufficiently cleaned, etc.

The material removed from the objects 1504 (e.g., powder 1508 and/or debris) can land in second collector 1516 (e.g., a tray, basket, bucket, or other receptacle) positioned below the first collector 1512. Optionally, the brush assembly 1500 can include one or more sieves and/or collectors between the first collector 1512 and the second collector 1516 for additional filtering of the removed material. The material within the second collector 1516 can subsequently be transported from the brush assembly 1500 to another process station, such as the waste station 1112 of FIG. 11. In some embodiments, the powder 1508 removed through the brushing process has a higher likelihood of being degraded (e.g., due to closer exposure to sintering energy) and thus is discarded rather than reused. The brush assembly 1500 can be operably coupled to a vacuum pump (not shown) that collects the material within the second collector 1516 and transfers the material to the waste station 1112. The vacuum pump can be made of an anti-static material and/or be electrically grounded to reduce the risk of powder explosion, as described elsewhere herein. Alternatively or in combination, the brush assembly 1500 can use other techniques for transporting the removed material, such as sweeping, pouring, blowing, etc.

The brush assembly 1500 illustrated in FIG. 15 can be modified in many ways. For instance, although all of the brushes are depicted as being rotary brushes, the brush assembly 1500 can alternatively or additionally include other types of brushes, such as flat brushes, brush strips, etc. Additionally, although the embodiment of FIG. 15 includes eight brushes, in other embodiments, the number of brushes can be varied, e.g., the brush assembly 1500 can include one, two, three, four, five, six, seven, nine, 10, 20, or more brushes. Some or all of the brushes of the brush assembly 1500 can be arranged in other configurations besides brush pairs, e.g., the brush assembly 1500 can include single brushes, sets of three or more aligned brushes, and so on. The sizes of the brushes can also be varied, such that some or all of the brushes can have different lengths and/or diameters. Moreover, although FIG. 15 shows brushes arranged in four vertical levels, the brush assembly 1500 can alternatively include a different number of vertical levels of brushes, such as one, two, three, five, or more vertical levels.

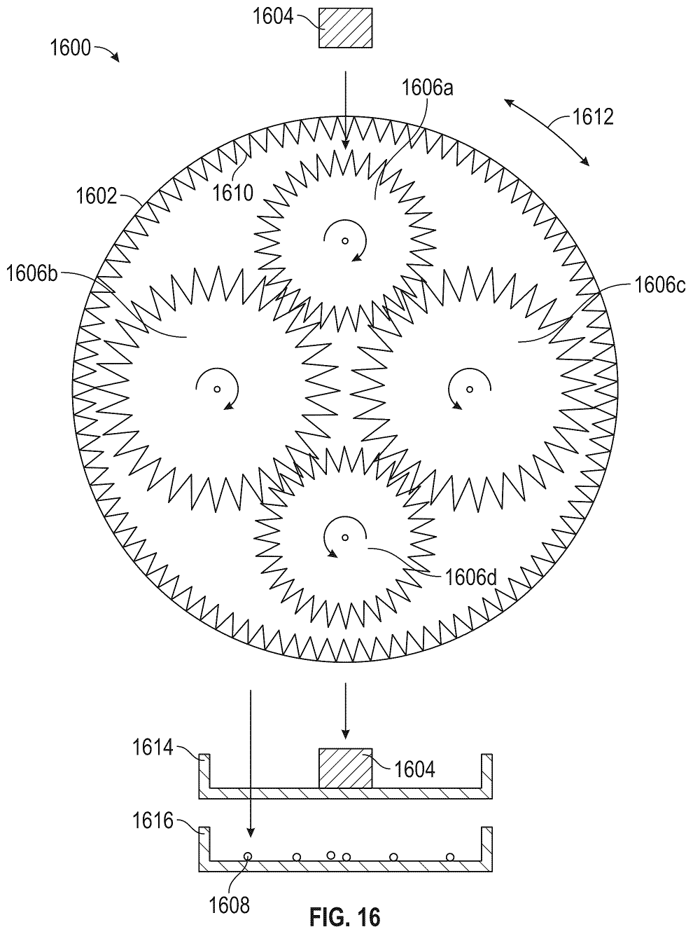

FIG. 16 is a partially schematic side view of another brush assembly 1600 that can be included in the second cleaning station 1110, in accordance with embodiments of the present technology. The brush assembly 1600 can be used as an alternative or in addition to the brush assembly 1500 of FIG. 15.

The brush assembly 1600 includes a housing 1602 (e.g., a drum, barrel, or other rotatable enclosure) which can be sealed (e.g., hermetically sealed) so that loose powder produced by the operation of the brush assembly 1600 does not escape into the surrounding environment. Optionally, the housing 1602 can have anti-static properties (e.g., be made partially or entirely out of an anti-static material) and/or be electrically grounded to reduce the risk of powder explosion due to electrostatic discharge. Although the housing 1602 is depicted as being a cylindrical component having a circular cross-sectional shape, in other embodiments, the housing 1602 can have a different shape, such as spherical, rectangular, square, etc.

The housing 1602 can include an opening (e.g., door, hatch, lid—not shown) to allow one or more additively manufactured objects 1604 to be transferred into the brush assembly 1600 (e.g., from the first cleaning station 1106 or a conveyor operably coupled to the first cleaning station 1106). The opening can be positioned at any suitable location in the housing 1602, such as an end wall or a side wall of the housing 1602, depending on the location of the brush assembly 1600 relative to the first cleaning station 1106 and/or conveyor. For example, in embodiments where the objects 1604 are transported to the brush assembly 1600 via an angled belt or chute, the brush assembly 1600 can be positioned below the output end of the angled belt or chute, and the housing 1602 can be rotated or tilted so that the opening is positioned at the upper portion of the housing 1602, such that the objects 1604 fall through the opening and into interior of the housing 1602 via gravity.

The brush assembly 1600 can include a plurality of rotary brushes 1606a-1606d (collectively, “rotary brushes 1606”) configured to clean the objects 1604. Although FIG. 16 depicts four rotary brushes 1606, in other embodiments, the brush assembly 1600 can include a different number of rotary brushes 1606, such as one, two, three, five, 10, 20, or more rotary brushes 1606. Each rotary brush 1606 can have an elongate, cylindrical body and a plurality of brush features (e.g., fibers, bristles, fins) extending radially outward from the body. The brush features can be made out of any suitable material (e.g., synthetic polymers, natural materials, metals), depending on the material of the objects 1604, desired degree of cleaning, etc. The rotary brushes 1606 can each rotate around a respective axis of rotation in a clockwise direction, a counterclockwise direction, or both. As the objects 1604 pass by the rotary brushes 1606, the rotating brush features of the rotary brushes 1606 can contact the surfaces of the objects 1604 to apply brushing forces that remove residual material (e.g., precursor material such as powder 1608, and/or other unwanted components such as debris).

In the illustrated embodiment, the rotary brushes 1606 are arranged in a cluster including an upper rotary brush 1606a, two lateral rotary brushes 1606b and 1606c, and a lower rotary brush 1606d. Each rotary brush 1606 can be spaced apart from one or more neighboring rotary brushes 1606 by a separation distance that is sufficiently large to allow the objects 1604 to pass between the rotary brushes 1606, but sufficiently small so that the brush features can contact the surfaces of the objects 1604. Optionally, the spacing can be adjustable to accommodate different object sizes. In such embodiments, some or all of the rotary brushes 1606 can be coupled to a linear actuator, mounted on a track, or otherwise movable relative to each other to increase or decrease the separation distance.

The sizes of the rotary brushes 1606 can be varied as desired. For example, as shown in FIG. 16, the upper rotary brush 1606a and lower rotary brush 1606d can have a first diameter, and the lateral rotary brushes 1606b, 1606c can have a second, larger diameter. Alternatively, the second diameter of the lateral rotary brushes 1606b, 1606c can be smaller than the first diameter of the upper rotary brush 1606a and lower rotary brush 1606d. Moreover, in other embodiments, each of the rotary brushes 1606 can have the same diameter, each of the rotary brushes 1606 can have a different diameter, or the brush assembly 1600 can include any suitable combination of rotary brushes 1606 having the same or different diameters.

The rotary brushes 1606 can each independently rotate in any suitable direction. In the illustrated embodiment, for instance, the upper rotary brush 1606a and lateral rotary brush 1606b rotate clockwise, while the lower rotary brush 1606d and lateral rotary brush 1606c rotate counterclockwise. In other embodiments, however, some or all of the rotary brushes 1606 can rotate in a different direction than the direction depicted in FIG. 16. Moreover, the rotation direction of the rotary brushes 1606 can change periodically during the operation of the brush assembly 1600. The rotation direction and/or speed of the rotary brushes 1606 can be selected to efficiently remove residual material from the objects object 1604 while avoiding damage to the objects 1604, and can be selected based on the object type (e.g., type of dental appliance), material properties of the objects 1604, residual material type, residual material size (e.g., particle size), degree of adhesion between the residual material and the objects 1604, desired degree of cleaning, etc.

Once the objects 1604 are introduced into the housing 1602, the housing 1602 can rotate around a rotational axis in a clockwise direction, a counterclockwise direction, or both, as indicated by arrow 1612. Optionally, the housing 1602 can be configured to rotate around multiple rotational axes, such as two or three different rotational axes. The rotation of the housing 1602 can create a tumbling action that circulates the objects 1604 to enhance contact with the rotary brushes 1606 and/or facilitate material removal. The rotary brushes 1606 can rotate concurrently with the housing 1602, and the rotation of the rotary brushes 1606 can draw the objects 1604 into and through the spaces between the rotary brushes 1606. In general, the objects 1604 can travel from the upper portion of the housing 1602, through some or all of the rotary brushes 1606, and land at the bottom portion of the housing 1602. The rotation of the housing 1602 can then recirculate the objects 1604 back to the upper portion of the housing 1602 and into contact with the rotary brushes 1606 for further cleaning.

In some embodiments, the interior surface of the housing 1602 is partially or entirely covered with brush features 1610, such that the objects 1604 can also be cleaned by contact with the brush features 1610 of the housing 1602. The brush features 1610 of the housing 1602 can optionally be arranged in a helical configuration, such the brush features 1610 lift objects 704 at the bottom portion of the housing 1602 toward the upper portion of the housing 1602 as the housing 1602 rotates.

Optionally, the brush assembly 1600 can include additional components to enhance cleaning of the objects 1604, in combination with brushing the objects 1604. For instance, the brush assembly 1600 can include one or more temperature control elements (e.g., heating elements and/or cooling elements) to maintain the interior of the housing 1602 at an appropriate temperature. In some embodiments, the interior of the housing 1602 is maintained at a sufficiently low temperature to avoid warping of the objects 1604 and/or to offset frictional heating caused by brushing and tumbling, such as room temperature (e.g., 25° C.) and/or a temperature below the glass transition temperature of the objects 1604. Examples of temperature control elements include, but are not limited to, heat sinks, heating plates, heat lamps, heated fluid, thermoelectric coolers, cold plates, cooled fluid, and suitable combinations thereof. The temperature control elements can be located within the housing 1602 of the brush assembly 1600, can be located outside but thermally coupled to the housing 1602 (e.g., a heating or cooling jacket attached to the exterior of the housing, a device that pumps heated or cooled fluid into the housing 1602), or any suitable combination thereof.

As another example, the brush assembly 1600 can include one or more nozzles that apply pressurized fluid to the objects 1604 to facilitate cleaning of the objects 1604. For example, the fluid can be compressed air or another compressed gas to blow material off the objects 1604. Alternatively or in combination, the fluid can be a wash fluid (e.g., water, solvent) to rinse the residual material from the objects 1604. Heated or cooled fluids can also be applied to the objects 1604 to heat or cool the objects 1604 to a desired temperature, respectively. The nozzles can be positioned at any suitable location within the housing 1602, such as at the end walls and/or side wall of the housing 1602. Optionally, some or all of the nozzles can be incorporated into the rotary brushes 1606. The fluid can be applied to the objects 1604 before, during, and/or after brushing of the objects 1604 by the rotary brushes 1606 and/or brush features 1610.

Alternatively or in combination, the nozzles can apply pressurized fluid (e.g., compressed air) to some or all of the rotary brushes 1606 and/or to the brush features 1610 to clean removed material (e.g., powder 1608) from the rotary brushes 1606 and/or brush features 1610. This approach can be used in situations where the removed material may adhere to the brushes, which may clog or otherwise reduce the cleaning efficacy over time. In such embodiments, the fluid can be applied to the rotary brushes 1606 and/or brush features 1610 continuously during operation of the brush assembly 1600, or can be applied at certain intervals (e.g., once every x minutes, after each batch of objects 1604, when sensor data indicates that the rotary brushes 1606 and/or brush features 1610 should be cleaned).

The brushing process can be performed for any suitable length of time, such as at least 1 minute, 5 minutes, 10 minutes, 15 minutes, 20 minutes, or 30 minutes. Optionally, the brushing process can be performed until data from one or more sensors indicates that the objects 1604 are sufficiently cleaned. In such embodiments, the brush assembly 1600 can include or be operably coupled to a sampling mechanism that periodically collects one or more objects 1604 to check the cleaning status. The sampled objects 1604 can be collected using a robotic arm, pick and place mechanism, pushers, moving belts, or any other suitable device, and transported to the sampling mechanism. The sampling mechanism can be located within the housing 1602 or can be at a separate location outside of the housing 1602.

The sampling mechanism can include one or more sensors that generate sensor data indicative of the cleaning status of the sampled objects 1604, such as any of the sensors previously described in connection with FIG. 15. The cleaning status of the objects 1604 can be evaluated based on measurements over time, such as whether the rate of change of characteristics such as surface roughness is decreasing. The cleaning status can also be evaluated based on the number or percentage of sampled objects 1604 that are considered sufficiently cleaned, such as whether the “pass” rate has exceeded a threshold value. The cleaning status determined from the sensor(s) can subsequently be used to control the operation of the brush assembly 1600, e.g., the brush assembly 1600 can stop operating once the objects 1604 are sufficiently cleaned, the brush assembly 1600 can continue operating and/or adjustments to the operating parameters can be made if the objects 1604 are not sufficiently cleaned, etc.

Once the objects 1604 are sufficiently cleaned, the objects 1604 can be removed from the housing 1602 and placed into a first collector 1614. For example, the housing 1602 can be rotated or tilted to allow the objects 1604 to fall out of the opening and into the first collector 1614 via gravity. The first collector 1614 can be a tray, basket, bucket, or other receptacle positioned below the housing 1602. In some embodiments, the first collector 1614 is a sieve including a plurality of openings (e.g., pores, perforations, slots—not shown) that allow removed material (e.g., powder 1608 and/or debris) to pass through while retaining the objects 1604. For instance, the size of openings can be larger than the size of the removed material but smaller than the size of the objects 1604. In some embodiments, the openings have an average width and/or diameter that is less than or equal to 20 mm, 10 mm, 5 mm, 2 mm, 1 mm, 0.5 mm, or 0.1 mm. The objects 1604 in the first collector 1614 can subsequently be transferred from the brush assembly 1600 to another process station (e.g., the collection station 1114 of FIG. 11), as described further below.

The material removed from the objects 1604 (e.g., powder 1608 and/or debris) can land in second collector 1616 (e.g., a tray, basket, bucket, or other receptacle) positioned below the first collector 1614. Optionally, the brush assembly 1600 can include one or more sieves and/or collectors between the first collector 1614 and the second collector 1616 for additional filtering of the removed material. The material within the second collector 1616 can subsequently be transported from the brush assembly 1600 to another process station, such as the waste station 1112 of FIG. 11. In some embodiments, the powder 1608 removed through the brushing process has a higher likelihood of being degraded (e.g., due to closer exposure to sintering energy) and thus is discarded rather than reused. The brush assembly 1600 can be operably coupled to a vacuum pump (not shown) that collects the material within the second collector 1616 and transfers the material to the waste station 1112. The vacuum pump can be made of an anti-static material and/or be electrically grounded to reduce the risk of powder explosion, as described elsewhere herein. Alternatively or in combination, the brush assembly 1600 can use other techniques for transporting the removed material, such as sweeping, pouring, blowing, etc.

The brush assembly 1600 illustrated in FIG. 16 can be modified in many ways. For instance, although all of the brushes are depicted as being rotary brushes, the brush assembly 1600 can alternatively or additionally include other types of brushes, such as flat brushes, brush strips, etc. Additionally, although the embodiment of FIG. 16 includes four rotary brushes 1606, in other embodiments, the number of brushes can be varied, e.g., the brush assembly 1600 can include one, two, three, five, six, seven, eight nine, 10, 20, or more brushes. Although the rotary brushes 1606 are illustrated as being oriented in the same direction, some or all of the rotary brushes 1606 can alternatively be oriented in different directions. Moreover, although FIG. 16 shows one upper rotary brush 1606a, two lateral rotary brushes 1606b and 1606c, and one lower rotary brush 1606d, the brush assembly 1600 can alternatively include different numbers of upper, lateral, and/or lower rotary brushes 1606.

Referring again to FIG. 11, after brushing, the one or more additively manufactured objects can be transferred from the second cleaning station 1110 to the collection station 1114. The collection station 1114 can be positioned proximate to a door, hatch, lid, or other opening in the housing 1102 (not shown) that allows the cleaned objects to be transferred out of the housing 1102 (e.g., manually by a human operator or automatically by a robotic assembly, conveyor belt, or other transport mechanism). The collection station 1114 can include a tray, frame, container, or other component suitable for receiving and supporting the cleaned objects.

In some embodiments, the cleaned objects are transferred from the second cleaning station 1110 to the collection station 1114 via a conveyor. The conveyor can use any suitable technique for transferring the objects, such as pushing the objects to a target location using a blade, plate, piston, etc.; picking up the objects using a robotic arm, pick and place mechanism, etc., and placing the objects at the target location; transporting the objects to the target location using moving belts, rollers, tracks, etc.; pouring the objects into or onto the target location with aid of gravity; using pipes and a vacuum pump to transport the objects to the target location via suction; or suitable combinations thereof. The transfer can be performed in an automated manner such that little or no manual intervention is involved. In other embodiments, however, the collection station 1114 can be part of the second cleaning station 1110 (e.g., the collection station 1114 can be the first collector 1512 of FIG. 15 or the first collector 1614 of FIG. 16), such that the conveyor can be omitted.

The waste material (e.g., nonreusable precursor material, debris) generated during processing of the one or more additively manufactured objects can be transferred to the waste station 1112. The waste station 1112 can collect and store the waste material in a container within the housing 1102, or can transport the waste material to a location outside of the housing 1102 (e.g., via pumps, pipes, and/or other suitable devices). Moreover, although FIG. 11 illustrates the waste station 1112 as being within the housing 1102, in other embodiments, the waste station 1112 can be a separate component that is located outside of the housing 1102.

In some embodiments, the waste material is transferred from the first cleaning station 1106 and/or the second cleaning station 1110 to the waste station 1112 via one or more conveyors. The conveyors can use any suitable technique for transferring the waste material, such as pushing the waste material to a target location using a blade, plate, piston, etc.; picking up the waste material using a robotic arm, pick and place mechanism, etc., and placing the water material at the target location; transporting the waste material to the target location using moving belts, rollers, tracks, etc.; pouring the waste material into or onto the target location with aid of gravity; using pipes and a vacuum pump to transport the waste material to the target location via suction; or suitable combinations thereof. The transfer can be performed in an automated manner such that little or no manual intervention is involved. In other embodiments, however, the waste station 1112 can be part of the first cleaning station 1106 and/or the second cleaning station 1110 (e.g., the waste station 1112 can be the second collector 1516 of FIG. 15 or the second collector 1616 of FIG. 16), such that the conveyors can be omitted.

The system 1100 can include at least one controller 1116 that is operably coupled to some or all of the stations 1104-1114 of the system 1100. The controller 1116 can be or include a computing device including one or more processors and memory storing instructions for performing the operations described herein. For example the controller 1116 can perform some or all of the following operations: monitoring loading of additively manufactured objects into the intake station 1104, effectuating transfer of the objects from the intake station 1104 to the centrifuge station 1106, effectuating centrifugation and/or other cleaning processes by the first cleaning station 1106, controlling operational parameters of the first cleaning station 1106 (e.g., centrifugation parameters and/or vibrational parameters), monitoring operational status of the first cleaning station 1106 via one or more sensors, monitoring cleaning status of objects in the first cleaning station 1106 via one or more sensors, effectuating transfer of the objects from the first cleaning station 1106 to the second cleaning station 1110 via the conveyor, effectuating brushing and/or other cleaning processes by the second cleaning station 1110, controlling operational parameters of the second cleaning station 1110, monitoring operational status of the second cleaning station 1110 via one or more sensors, monitoring cleaning status of objects in the second cleaning station 1110 via one or more sensors, effectuating transfer of the objects from the second cleaning station 1110 to the collection station 1114, effectuating transfer of reusable material from the first cleaning station 1106 to the recycling station 1108, effectuating transfer of waste material from the first cleaning station 1106 and/or second cleaning station 1110 to the waste station 1112, and/or outputting notifications to an operator (e.g., alerts indicating an error has occurred, messages indicating that cleaning is complete). Optionally, the controller 1116 can receive input from an operator indicating the type of objects to be cleaned (e.g., dental appliance, material properties of the objects), and can automatically adjust the operational parameters of some or all of the stations (e.g., the first cleaning station 1106 and/or the second cleaning station 1110) based on the object type.

The configuration of the system 1100 can be modified in many ways. For example, any of the stations 1104-1114 illustrated in FIG. 11 can be combined into a single larger station, divided into multiple smaller substations, or omitted altogether. Each of the stations 1104-1114 can include any suitable combination of hardware and software components for performing the operations described herein. Moreover, the system 1100 can include other components not shown in FIG. 11, such as sensors, user interface devices, conveyors to route objects and/or materials between stations, other types of process stations, etc. In some embodiments, for example, the system 1100 includes other types of cleaning stations that can be used as an alternative or in addition to the first cleaning station 1106 and/or the second cleaning station 1110 (e.g., in embodiments where the objects are made out of a different type of precursor material such as a resin). For instance, the system 1100 can alternatively or additionally include an ultrasonic cleaning station that cleans the objects via immersion in an ultrasonic bath, a wash station that cleans the objects by soaking and/or rinsing with water or solvents, a drying station that removes volatile components via evaporation, etc.; or any of these cleaning techniques can be incorporated into the first cleaning station 1106 and/or the second cleaning station 1110. In some embodiments, the first cleaning station 1106 or the second cleaning station 1110 may be omitted, such the system 1100 includes a single cleaning station only. Additionally, the order of operations shown in FIG. 11 can be varied.

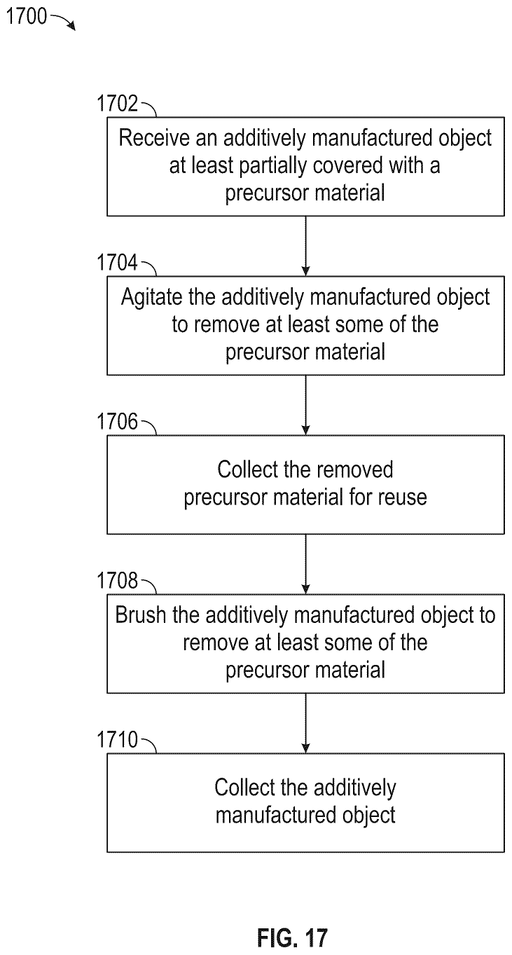

FIG. 17 is a flow diagram illustrating a method 1700 for processing an additively manufactured object, in accordance with embodiments of the present technology. The method 1700 can be performed by any of the systems and devices described herein, such as any of the embodiments of FIGS. 11-16. In some embodiments, some or all of the processes of the method 1700 are implemented as computer-readable instructions (e.g., program code) that are configured to be executed by one or more processors of a computing device, such as the controller 1116 of the system 1100 of FIG. 11.

The method 1700 can begin at block 1702 with receiving an additively manufactured object that is at least partially covered with a precursor material. For example, the object can be a dental appliance, such as an aligner, palatal expander, retainer, mouth guard, etc. Additional details and examples of dental appliances that are applicable to the present technology are provided in Section II below. The object can be fabricated using any suitable additive manufacturing process. For example, the object can be fabricated from a powder (e.g., polymeric powder) using a powder bed fusion process, such as the SLS process described above in connection with FIG. 2A. After the powder bed fusion process is completed, the object can be partially or fully surrounded by unfused powder, and thus may need to be separated from the powder before the object can be prepared for use. In other embodiments, the object can be fabricated using other types of additive manufacturing processes, as described in Section III below.

At block 1704, the method 1700 can continue with agitating the additively manufactured object to remove at least some of the precursor material. The agitation can include applying mechanical forces to the object (e.g., rotating, tumbling, vibrating, etc.) to separate the precursor material from the object. In some embodiments, the agitation involves rotating the additively manufactured object, and the rotation can be performed using a centrifuge, as described herein in connection with FIGS. 11 and 14. For example, in embodiments where the objects are initially embedded in a powder cake, the centrifugation can break apart the powder cake and separate the loose powder from the objects. The centrifugation can also remove other unwanted material that is present in the powder cake, such as debris (e.g., agglomerated powder, chunks, contaminants).

In some embodiments, the agitation includes vibrating the objects, and the vibration can be performed using a vibrating platform (e.g., a vibrating centrifuge, drum, table, etc.). For example, in embodiments where the objects are initially embedded in a powder cake, the vibration can break apart the powder cake and separate the loose powder from the objects. The vibration can also remove other unwanted material that is present in the powder cake, such as debris (e.g., agglomerated powder, chunks, contaminants). Optionally, the vibrating platform can include holes formed therein to allow loose powder, debris, etc., to be separated from the object via sieving.

In some embodiments, the process of block 1704 involves both centrifuging and vibrating the object (e.g., concurrently or sequentially). In some embodiments, the process of block 1704 involves centrifuging the object, without vibrating the object. In some embodiments, the process of block 1704 involves vibrating the object, without centrifuging the object.

The centrifugation parameters (e.g., force, rotation speed, rotation direction, rotation time, ramp up time, ramp up rate, ramp down time, ramp down rate, environmental temperature) and/or vibration parameters (vibration amplitude, vibration frequency, timing) can be selected to efficiently remove residual material from the object while avoiding damage to the object. The centrifugation and/or vibration parameters can be the appropriate vibration parameters can be determined based on the object type (e.g., type of dental appliance), material properties of the object, residual material type, residual material size (e.g., particle size), degree of adhesion between the residual material and the object, desired degree of cleaning, and/or other relevant considerations. Optionally, the centrifugation and/or vibration parameters can be configured to remove unadhered or loosely adhered powder that is suitable for reuse, while avoiding removal of more tightly adhered powder that may not be suitable for reuse.

At block 1706, the method 1700 can optionally include collecting the removed precursor material from the process of block 1704 for reuse. In some embodiments, the material that is removed via agitating (e.g., rotating and/or vibrating) the object is loosely adhered or unadhered powder that is less likely to be degraded (e.g., due to lower exposure to sintering energy), and thus can be reused in subsequent additive manufacturing processes. Optionally, the process of block 1706 can further include mixing the collected precursor material with fresh precursor material and/or other processes to prepare the material for reuse, as described elsewhere herein.

At block 1708, the method 1700 can continue with brushing the additively manufactured object to remove at least some of the precursor material. The brushing can be performed by a brushing assembly, as described herein in connection with FIGS. 11, 15, and 16. For example, the brushing process can include contacting the object with one or more rotary brushes that apply a brushing force to remove some or all of the remaining precursor material on the object. In some embodiments, the precursor material removed by the brushing process is more tightly adhered and is not reused, due to a higher likelihood of being degraded (e.g., due to closer exposure to sintering energy). Thus, the precursor material removed in the process of block 1708 can be discarded.

At block 1710, the method 1700 can include collecting the additively manufactured object. The object can then undergo additional post-processing (e.g., surface modifications, washing, post-curing, trimming, packaging) and/or be prepared for shipment and use.

The method 1700 illustrated in FIG. 17 can be modified in many different ways. For example, although the above processes of the method 1700 are described with respect to a single object, the method 1700 can be used to sequentially or concurrently fabricate and post-process any suitable number of objects, such as tens, hundreds, or thousands of additively manufactured objects. As another example, the ordering of the processes shown in FIG. 17 can be varied (e.g., the process of block 1708 can be performed before the process of block 1704). Some of the processes of the method 1700 can be omitted, such as the process of block 1706.

The method 1700 can also include additional processes not shown in FIG. 17. For instance, the method 1700 can further include collecting the precursor material removed by the brushing process of block 1708 for disposal. In some embodiments, some or all of the processes of the method 1700 are performed at different locations and/or by different devices (e.g., the process of block 1702 can be performed by the intake station 1104 of the system 1100 of FIG. 11, the process of block 1704 can be performed by the first cleaning station 1106, the process of block 1706 can be performed by the recycling station 1108, the process of block 1708 can be performed by the second cleaning station 1110, and/or the process of block 1710 can be performed by the collection station 1114). In such embodiments, the method 1700 can further include transporting the object from a first location and/or device to a second location and/or device using an automated conveyor, such as any of the embodiments provided herein. As another example, the method 1700 can include other types of cleaning processes, such as acoustic cleaning (e.g., ultrasonic cleaning), which can be performed in addition or as an alternative to the process of block 1704 and/or the process of block 1708.

### II. Dental Appliances and Associated Methods

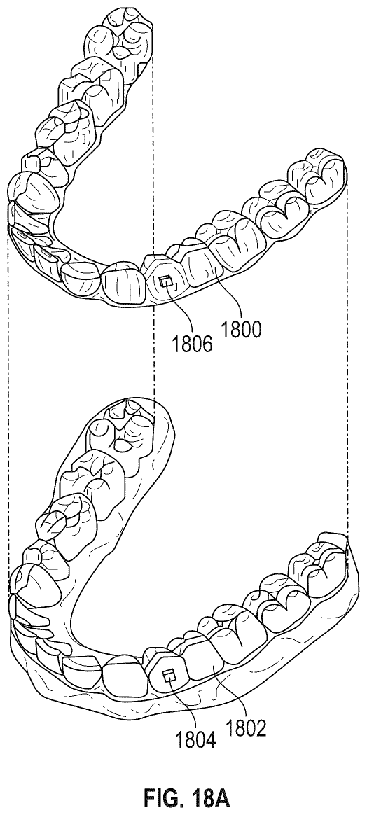

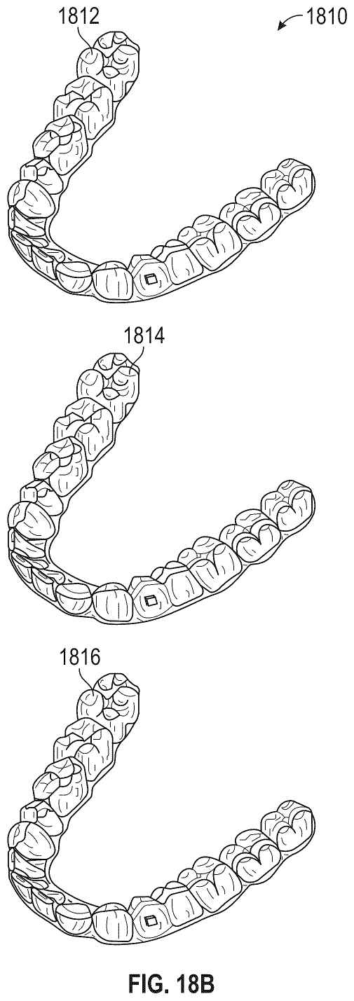

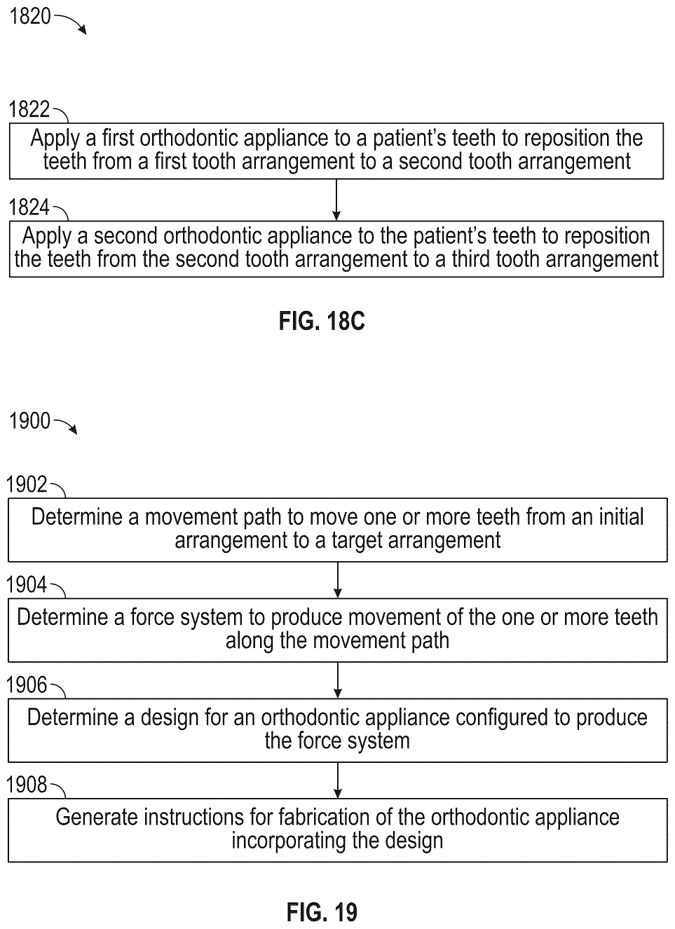

FIG. 18A illustrates a representative example of a tooth repositioning appliance 1800 configured in accordance with embodiments of the present technology. The appliance 1800 can be manufactured using any of the systems, methods, and devices described herein. The appliance 1800 (also referred to herein as an “aligner”) can be worn by a patient in order to achieve an incremental repositioning of individual teeth 1802 in the jaw. The appliance 1800 can include a shell (e.g., a continuous polymeric shell or a segmented shell) having teeth-receiving cavities that receive and resiliently reposition the teeth. The appliance 1800 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1800 can fit over all teeth present in an upper or lower jaw, or less than all of the teeth. The appliance 1800 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1800 can be a generic appliance configured to receive the teeth, but not necessarily shaped to match the topography of the patient's teeth. In some cases, only certain teeth received by the appliance 1800 are repositioned by the appliance 1800 while other teeth can provide a base or anchor region for holding the appliance 1800 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1800 in place over the teeth. In some cases, however, it may be desirable or necessary to provide individual attachments 1804 or other anchoring elements on teeth 1802 with corresponding receptacles 1806 or apertures in the appliance 1800 so that the appliance 1800 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 18B illustrates a tooth repositioning system 1810 including a plurality of appliances 1812, 1814, 1816, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1810 can include a first appliance 1812 corresponding to an initial tooth arrangement, one or more intermediate appliances 1814 corresponding to one or more intermediate arrangements, and a final appliance 1816 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 18C illustrates a method 1820 of orthodontic treatment using a plurality of appliances, in accordance with embodiments of the present technology. The method 1820 can be practiced using any of the appliances or appliance sets described herein. In block 1822, a first orthodontic appliance is applied to a patient's teeth in order to reposition the teeth from a first tooth arrangement to a second tooth arrangement. In block 1824, a second orthodontic appliance is applied to the patient's teeth in order to reposition the teeth from the second tooth arrangement to a third tooth arrangement. The method 1820 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 19 illustrates a method 1900 for designing an orthodontic appliance, in accordance with embodiments of the present technology. The method 1900 can be applied to any embodiment of the orthodontic appliances described herein. Some or all of the steps of the method 1900 can be performed by any suitable data processing system or device, e.g., one or more processors configured with suitable instructions.

In block 1902, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1904, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1904 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1906, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1908, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1900 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1900 may be performed with any suitable fabrication system or device, such as the embodiments described herein. Some of the steps may be optional, e.g., the process of block 1904 can be omitted, such that the orthodontic appliance is designed based on the desired tooth movements and/or determined tooth movement path, rather than based on a force system. Moreover, the order of the steps can be varied as desired.

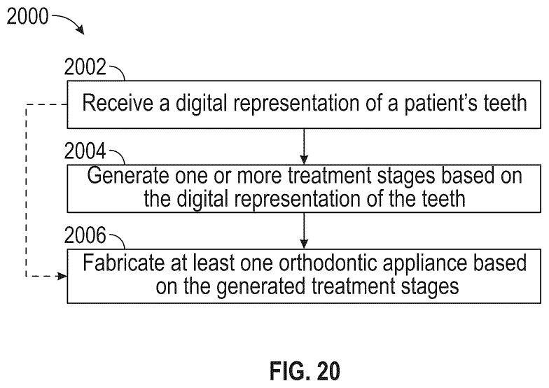

FIG. 20 illustrates a method 2000 for digitally planning an orthodontic treatment and/or design or fabrication of an appliance, in accordance with embodiments. The method 2000 can be applied to any of the treatment procedures described herein and can be performed by any suitable data processing system.

In block 2002 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 2004, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 2006, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 20, design and/or fabrication of an orthodontic appliance, and perhaps a particular orthodontic treatment, may include use of a representation of the patient's teeth (e.g., including receiving a digital representation of the patient's teeth (block 2002)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled, “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled, “Dental Attachment Placement Structure,” filed Jun. 14, 2017; U.S. application Ser. No. 14/963,527, entitled, “Dental Attachment Placement Structure,” filed Dec. 9, 2015; U.S. application Ser. No. 14/939,246, entitled, “Dental Attachment Placement Structure,” filed Nov. 12, 2015; U.S. application Ser. No. 14/939,252, entitled, “Dental Attachment Formation Structures,” filed Nov. 12, 2015; and U.S. Pat. No. 9,700,385, entitled, “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled, “Releasable Palatal Expanders,” filed Apr. 10, 2019; U.S. application Ser. No. 16/22,552, entitled, “Devices, Systems, and Methods for Dental Arch Expansion,” filed Jun. 28, 2018; U.S. Pat. No. 11,45,283, entitled, “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled, “Methods and Apparatuses for Customizing a Rapid Palatal Expander,” filed Dec. 4, 2017; and U.S. Pat. No. 7,192,273, entitled, “System and Method for Palatal Expansion,” filed Aug. 7, 2003; all of which are incorporated by reference herein in their entirety.

### III. Overview of Additive Manufacturing Technology

The embodiments of the present technology are suitable for use with a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform, such as using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry (e.g., inkjet printing).

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

### EXAMPLES

The following examples are included to further describe some aspects of the present technology, and should not be used to limit the scope of the technology.

Example 1. A system for processing one or more additively manufactured objects that are at least partially covered with a precursor material, the system comprising:
a cleaning station configured to agitate the one or more additively manufactured objects to remove at least some of the precursor material from the one or more additively manufactured objects;
a brush assembly configured to brush the one or more additively manufactured objects to remove at least some of the precursor material from the one or more additively manufactured objects; and
a conveyor configured to transport the one or more additively manufactured objects from the cleaning station to the brush assembly.

Example 2. The system of Example 1, wherein the cleaning station comprises a vibrating platform configured to vibrate the one or more additively manufactured objects.

Example 3. The system of Example 1 or 2, wherein the cleaning station comprises a centrifuge configured to rotate the one or more additively manufactured objects.

Example 4. The system of Example 3, wherein the centrifuge is configured to vibrate while rotating the one or more additively manufactured objects.

Example 5. The system of Example 3 or 4, wherein the centrifuge comprises a receptacle configured to receive the one or more additively manufactured objects, the receptacle having a plurality of openings sized to retain the one or more additively manufactured objects within the receptacle while permitting the precursor material to exit the receptacle.

Example 6. The system of any one of Examples 3 to 5, further comprising one or more sieves positioned proximate to the centrifuge, wherein the one or more sieves are configured to separate the precursor material from debris.

Example 7. The system of any one of Examples 1 to 6, further comprising a container configured to collect the precursor material removed by the cleaning station.

Example 8. The system of any one of Examples 1 to 7, wherein the brush assembly comprises a plurality of rotary brushes.

Example 9. The system of Example 8, wherein the plurality of rotary brushes comprise a series of rotary brush pairs arranged in a vertical configuration.

Example 10. The system of Example 9, wherein the one or more additively manufactured objects pass through the series of rotary brush pairs via gravity.

Example 11. The system of Example 8, wherein the plurality of rotary brushes are positioned within a rotating chamber.

Example 12. The system of Example 11, wherein the rotating chamber comprises an interior surface, and the interior surface is at least partially covered with brush features.

Example 13. The system of any one of Examples 1 to 12, further comprising one or more sieves configured to separate the one or more additively manufactured objects from the precursor material removed by the brush assembly.

Example 14. The system of any one of Examples 1 to 13, wherein the conveyor comprises one or more moving belts positioned between the cleaning station and the brush assembly.

Example 15. The system of any one of Examples 1 to 14, further comprising a housing enclosing the cleaning station, the brush assembly, and the conveyor.

Example 16. The system of any one of Examples 1 to 15, further comprising an intake station configured to receive a powder cake comprising the one or more additively manufactured objects and the precursor material.

Example 17. The system of Example 16, wherein the powder cake is initially positioned on a build platform, and the intake station comprises a movable blade configured to sweep the powder cake off the build platform and into the cleaning station.

Example 18. The system of any one of Examples 1 to 17, further comprising one or more sensors configured to monitor operation of one or more of the centrifuge, the brush assembly, or the conveyor.

Example 19. The system of any one of Examples 1 to 18, further comprising one or more sensors configured to monitor cleaning status of the one or more additively manufactured objects.

Example 20. The system of any one of Examples 1 to 19, further comprising a controller operably coupled to one or more of the cleaning station, the brush assembly, or the conveyor.

Example 21. The system of any one of Examples 1 to 20, wherein the precursor material comprises a polymeric powder.

Example 22. The system of any one of Examples 1 to 21, wherein the one or more additively manufactured objects comprise one or more dental appliances.

Example 23. A system comprising:
a processor; and
a memory operably coupled to the processor and storing instructions that, when executed by the processor, cause the system to perform operations comprising:
   receiving one or more additively manufactured objects that are at least partially covered with a precursor material,
   agitating the one or more additively manufactured objects via a cleaning station to remove at least some of the precursor material,
   transporting the one or more additively manufactured objects from the cleaning station to a brush assembly via a conveyor, and
   brushing the one or more additively manufactured objects via the brush assembly to remove at least some of the precursor material.

Example 24. The system of Example 23, wherein the agitating comprises one or more of vibrating or rotating the one or more additively manufactured objects.

Example 25. The system of Example 23 or 24, wherein the cleaning station comprises a vibrating platform.

Example 26. The system of any one of Examples 23 to 25, wherein the cleaning station comprises a centrifuge, wherein the centrifuge comprises a receptacle configured to receive the one or more additively manufactured objects, the receptacle having a plurality of openings sized to retain the one or more additively manufactured objects within the receptacle while permitting the precursor material to exit the receptacle.

Example 27. The system of Example 26, further comprising one or more sieves positioned proximate to the centrifuge, wherein the one or more sieves are configured to separate the precursor material from debris.

Example 28. The system of Example 26 or 27, further comprising a container configured to collect the precursor material removed by the centrifuge.

Example 29. The system of any one of Examples 23 to 28, further comprising the brush assembly, wherein the brush assembly comprises a plurality of rotary brushes.

Example 30. The system of Example 29, wherein the plurality of rotary brushes comprise a series of rotary brush pairs arranged in a vertical configuration.

Example 31. The system of Example 29, wherein the plurality of rotary brushes are positioned within a rotating chamber.

Example 32. The system of any one of Examples 23 to 31, further comprising one or more sieves configured to separate the one or more additively manufactured objects from the precursor material removed by the brush assembly.

Example 33. The system of any one of Examples 23 to 32, further comprising the conveyor, wherein the conveyor comprises one or more moving belts positioned between the cleaning station and the brush assembly.

Example 34. The system of any one of Examples 23 to 33, further comprising a housing enclosing the cleaning station, the brush assembly, and the conveyor.

Example 35. The system of any one of Examples 23 to 34, wherein the one or more additively manufactured objects are received on a build platform, and the operations further comprise sweeping the additively manufactured objects off the build platform and into a cleaning station.

Example 36. The system of any one of Examples 23 to 35, wherein the operations further comprise receiving sensor data indicative of an operational status of one or more of the cleaning station, the brush assembly, or the conveyor.

Example 37. The system of any one of Examples 23 to 36, wherein the operations further comprise receiving sensor data indicative of a cleaning status of the one or more additively manufactured objects.

Example 38. The system of any one of Examples 23 to 37, wherein the precursor material comprises a polymeric powder.

Example 39. The system of any one of Examples 23 to 38, wherein the one or more additively manufactured objects comprise one or more dental appliances.

Example 40. A method comprising:
receiving one or more additively manufactured objects that are at least partially covered with a precursor material;
agitating the one or more additively manufactured objects via a cleaning station to remove at least some of the precursor material;
transporting the one or more additively manufactured objects from the cleaning station to a brush assembly via a conveyor; and
brushing the one or more additively manufactured objects via the brush assembly to remove at least some of the precursor material.

Example 41. The method of Example 40, wherein the agitating comprises one or more of vibrating or rotating the one or more additively manufactured objects.

Example 42. The method of Example 40 or 41, wherein the cleaning station comprises a vibrating platform.

Example 43. The method of any one of Examples 40 to 42, wherein the cleaning station comprises a centrifuge, wherein the centrifuge comprises a receptacle configured to receive the one or more additively manufactured objects, the receptacle having a plurality of openings sized to retain the one or more additively manufactured objects within the receptacle while permitting the precursor material to exit the receptacle.

Example 44. The method of Example 43, further comprising separating the precursor material removed by the centrifuge from debris.

Example 45. The method of any one of Examples 40 to 44, further collecting the precursor material removed by the cleaning station for reuse.

Example 46. The method of Example 45, further comprising mixing the collected precursor material with fresh precursor material.

Example 47. The method of any one of Examples 40 to 46, wherein the brush assembly comprises a plurality of rotary brushes.

Example 48. The method of Example 47, wherein the plurality of rotating brushes comprise a series of rotary brush pairs arranged in a vertical configuration.

Example 49. The method of Example 47, wherein the plurality of rotary brushes are positioned within a rotating chamber.

Example 50. The method of any one of Examples 40 to 49, further comprising separating the one or more additively manufactured objects from the precursor material removed by the brush assembly.

Example 51. The method of any one of Examples 40 to 50, wherein the conveyor comprises one or more moving belts positioned between the cleaning station and the brush assembly.

Example 52. The method of any one of Examples 40 to 51, wherein the cleaning station, the brush assembly, and the conveyor are enclosed by a housing.

Example 53. The method of any one of Examples 40 to 52, wherein the one or more additively manufactured objects are received on a build platform, and the method further comprises sweeping the additively manufactured objects off the build platform and into the cleaning station.

Example 54. The method of any one of Examples 40 to 53, further comprising receiving sensor data indicative of an operational status of one or more of the cleaning station, the brush assembly, or the conveyor.

Example 55. The method of any one of Examples 40 to 54, further comprising receiving sensor data indicative of a cleaning status of the one or more additively manufactured objects.

Example 56. The method of any one of Examples 40 to 55, wherein the precursor material comprises a polymeric powder.

Example 57. The method of any one of Examples 40 to 56, wherein the one or more additively manufactured objects comprise one or more dental appliances.

Example 58. The method of any one of Examples 40 to 57, further comprising cooling the one or more additively manufactured objects and the precursor material from an elevated temperature to a target temperature, before agitating the one or more additively manufactured objects.

Example 59. The method of Example 58, wherein the cooling is performed while the one or more additively manufactured objects and the precursor material are within an inert environment.

Example 60. The method of Example 58 or 59, further comprising monitoring a cooling status of the one or more additively manufactured objects using at least one sensor.

Example 61. A non-transitory computer-readable storage medium comprising instructions that, when executed by one or more processors of a system, cause the system to perform operations comprising:
receiving one or more additively manufactured objects that are at least partially covered with a precursor material,
agitating the one or more additively manufactured objects via a cleaning station to remove at least some of the precursor material,
transporting the one or more additively manufactured objects from the cleaning station to a brush assembly via a conveyor, and
brushing the one or more additively manufactured objects via the brush assembly to remove at least some of the precursor material.

Example 62. A system for cooling one or more additively manufactured objects, the system comprising:
a plurality of compartments, wherein each compartment comprises:
   a chamber configured to receive a set of additively manufactured objects,
   a port configured to fluidically couple the chamber to a source of an inert gas, and
   a sensor configured to generate sensor data indicative of a cooling status of the set of additively manufactured objects; and
a controller operably coupled to the plurality of compartments, wherein the controller is configured to monitor the cooling status of the set of additively manufactured objects within each compartment based on the corresponding sensor data.

Example 63. The system of Example 62, wherein each compartment is configured to receive a build container holding the set of additively manufactured objects.

Example 64. The system of Example 63, wherein the build container holds a powder cake comprising the set of additively manufactured objects embedded at least partially within a precursor material.

Example 65. The system of Example 64, wherein the precursor material comprises a polymeric powder.

Example 66. The system of any one of Examples 62 to 65, wherein the build container comprises a bottom wall and a plurality of sidewalls, and wherein the bottom wall is a build platform for the set of additively manufactured objects.

Example 67. The system of any one of Examples 62 to 66, wherein the chamber is configured to fluidically seal the set of additively manufactured objects from external air.

Example 68. The system of any one of Examples 62 to 67, wherein the controller is configured to cause the inert gas to be introduced into the chamber to purge oxygen from within the chamber.

Example 69. The system of any one of Examples 62 to 68, wherein the sensor comprises a temperature sensor.

Example 70. The system of Example 69, wherein the temperature sensor comprises an elongate probe that is configured to be inserted into a powder cake containing the set of additively manufactured objects.

Example 71. The system of any one of Examples 62 to 70, wherein the cooling status comprises one or more of the following: a temperature of the set of additively manufactured objects, a cooling rate of the set of additively manufactured objects, a temperature of a powder cake containing the set of additively manufactured objects, or a cooling rate of the powder cake containing the set of additively manufactured objects.

Example 72. The system of any one of Examples 62 to 71, wherein the controller is configured to determine whether the set of additively manufactured objects has reached a target temperature based on the cooling status.

Example 73. The system of Example 72, wherein the controller is configured to output a notification upon determining that the set of additively manufactured objects has reached the target temperature.

Example 74. The system of any one of Examples 62 to 73, wherein the controller is configured to determine whether the set of additively manufactured objects is cooling according to a target cooling profile based on the cooling status.

Example 75. The system of Example 74, wherein the target cooling profile comprises one or more of the following: a minimum cooling rate, a maximum cooling rate, a target cooling rate, a minimum cooling time, a maximum cooling time, or a target cooling time.

Example 76. The system of any one of Examples 62 to 75, wherein each compartment comprises at least one active temperature control element.

Example 77. The system of Example 76, wherein the at least one active temperature control element comprises a heating device.

Example 78. The system of Example 76 or 77, wherein the at least one active temperature control element comprises a cooling device.

Example 79. The system of any one of Examples 76 to 78, wherein the controller is configured to control operation of the at least one active temperature control element based on the cooling status.

Example 80. The system of any one of Examples 62 to 79, further comprising a transport device configured to transport a set of additively manufactured objects to one of the plurality of compartments.

Example 81. The system of Example 80, wherein the transport device is a cart comprising a plurality of wheels.

Example 82. The system of Example 80 or 81, wherein the transport device comprises a chamber configured to receive the set of additively manufactured objects.

Example 83. The system of Example 82, wherein the chamber of the transport device is thermally insulated.

Example 84. The system of Example 82 or 83, wherein the chamber of the transport device is fluidically coupled to a reservoir of an inert gas.

Example 85. The system of any one of Examples 62 to 84, wherein the set of additively manufactured objects comprises a set of dental appliances.

Example 86. The system of any one of Examples 62 to 85, wherein the set of additively manufactured objects are fabricated using a powder bed fusion process.

Example 87. The system of Example 86, wherein the powder bed fusion process comprises selective laser sintering.

Example 88. A method comprising:
receiving an additively manufactured object within a chamber;
introducing an inert gas into the chamber;
cooling the additively manufactured object within the chamber; and
monitoring a cooling status of the additively manufactured within the chamber using at least one sensor.

Example 89. The method of Example 88, wherein the additively manufactured object is positioned within a build container.

Example 90. The method of Example 88 or 89, wherein the build container comprises a bottom wall and a plurality of sidewalls, and wherein the bottom wall is a build platform for the additively manufactured object.

Example 91. The method of any one of Examples 88 to 90, wherein the additively manufactured object is embedded at least partially within a precursor material.

Example 92. The method of Example 91, wherein the precursor material comprises a polymeric powder.

Example 93. The method of any one of Examples 88 to 92, wherein the introducing of the inert gas purges oxygen from within the chamber.

Example 94. The method of any one of Examples 88 to 93, further comprising fluidically sealing the additively manufactured object from external air.

Example 95. The method of any one of Examples 88 to 94, wherein the additively manufactured object is passively cooled.

Example 96. The method of any one of Examples 88 to 94, wherein the additively manufactured object is actively cooled using at least one cooling device.

Example 97. The method of Example 96, wherein the at least one cooling device comprises the inert gas.

Example 98. The method of any one of Examples 88 to 97, wherein the at least one sensor comprises a temperature sensor.

Example 99. The method of Example 98, wherein the temperature sensor comprises an elongate probe, and the method further comprises inserting the elongate probe into a powder cake containing the additively manufactured object.

Example 100. The method of Example 99, further comprising determining a height of the powder cake based on a distance that the elongate probe is lowered to make contact with the powder cake.

Example 101. The method of any one of Examples 88 to 100, wherein the cooling status comprises one or more of the following: a temperature of the additively manufactured object, a cooling rate of the additively manufactured object, a temperature of a powder cake containing the additively manufactured object, or a cooling rate of the powder cake containing the additively manufactured object.

Example 102. The method of any one of Examples 88 to 101, further comprising determining whether the additively manufactured object has reached a target temperature based on the cooling status.

Example 103. The method of Example 102, further comprising outputting a notification upon determining that the additively manufactured object has reached the target temperature.

Example 104. The method of any one of Examples 88 to 103, further comprising determining whether the additively manufactured object is cooling according to a target cooling profile based on the cooling status.

Example 105. The method of Example 104, wherein the target cooling profile comprises one or more of the following: a minimum cooling rate, a maximum cooling rate, a target cooling rate, a minimum cooling time, a maximum cooling time, or a target cooling time.

Example 106. The method of any one of Examples 88 to 105, further comprising controlling at least one active temperature control element based on the cooling status.

Example 107. The method of Example 106, wherein the at least one active temperature control element comprises a heating device configured to heat the additively manufactured object.

Example 108. The method of Example 106 or 107, wherein the at least one active temperature control element comprises a cooling device configured to cool the additively manufactured object.

Example 109. The method of any one of Examples 88 to 108, further comprising transferring the additively manufactured object from an additive manufacturing system to the chamber using a transport device.

Example 110. The method of Example 109, wherein the transport device is a cart comprising a plurality of wheels.

Example 111. The method of Example 109 or 110, wherein the transport device is configured to thermally insulate the additively manufactured object during the transfer.

Example 112. The method of any one of Examples 109 to 111, wherein the transport device is configured to fluidically isolate the additively manufactured object from external air during the transfer.

Example 113. The method of any one of Examples 88 to 112, wherein the additively manufactured object comprises a dental appliance.

Example 114. The method of any one of Examples 88 to 113, wherein the additively manufactured object is fabricated using a powder bed fusion process.

Example 115. The method of Example 114, wherein the powder bed fusion process comprises selective laser sintering.

Example 116. The method of any one of Examples 88 to 115, wherein the additively manufactured object is embedded at least partially within a precursor material, and wherein the method further comprises removing at least some of the precursor material from the additively manufactured object after the cooling of the additively manufactured object.

Example 117. The method of Example 116, wherein at least some of the precursor material is removed by agitating the additively manufactured object.

Example 118. The method of Example 117, wherein the agitating comprises one or more of vibrating or rotating the additively manufactured object.

Example 119. The method of any one of Examples 116 to 118, wherein at least some of the precursor material is removed by brushing the additively manufactured object.

Example 120. The method of any one of Examples 116 to 119, further comprising collecting at least some of the precursor material removed from the additively manufactured object for reuse.

Example 121. A method comprising:
receiving one or more additively manufactured objects that are at least partially covered with a precursor material;
cooling the one or more additively manufactured objects and the precursor material to a target temperature; and
removing at least some of the precursor material from the one or more additively manufactured objects via application of mechanical force.

Example 122. The method of Example 121, wherein the one or more additively manufactured objects and the precursor material are cooled within a chamber.

Example 123. The method of Example 122, further comprising introducing an inert gas into the chamber.

Example 124. The method of Example 123, wherein the introducing of the inert gas purges oxygen from within the chamber.

Example 125. The method of any one of Examples 122 to 124, further comprising fluidically sealing the chamber from external air.

Example 126. The method of any one of Examples 121 to 125, wherein the one or more additively manufactured objects and the precursor material are passively cooled.

Example 127. The method of any one of Examples 121 to 126, wherein the one or more additively manufactured objects and the precursor material are actively cooled using at least one cooling device.

Example 128. The method of any one of Examples 121 to 127, further comprising monitoring a cooling status of the one or more additively manufactured objects using at least one sensor.

Example 129. The method of Example 128, wherein the cooling status comprises one or more of the following: a temperature of the one or more additively manufactured objects, a cooling rate of the one or more additively manufactured objects, a temperature of a powder cake containing the one or more additively manufactured objects, or a cooling rate of the powder cake containing the one or more additively manufactured objects.

Example 130. The method of Example 128 or 129, further comprising determining whether the one or more additively manufactured objects have reached the target temperature based on the cooling status.

Example 131. The method of any one of Examples 121 to 130, wherein the removing comprises brushing the one or more additively manufactured objects.

Example 132. The method of Example 131, wherein the brushing is performed using a brush assembly.

Example 133. The method of Example 132, wherein the brush assembly comprises a plurality of rotary brushes.

Example 134. The method of any one of Examples 121 to 133, wherein the removing comprises agitating the one or more additively manufactured objects.

Example 135. The method of Example 134, wherein the agitating comprises one or more of vibrating or rotating the additively manufactured object.

Example 136. The method of Example 134 or 135, wherein the agitating is performed by a vibrating platform, by a centrifuge, or a combination thereof.

Example 137. The method of any one of Examples 121 to 136, further comprising collecting at least some of the precursor material removed from the one or more additively manufactured objects for reuse.

Example 138. The method of any one of Examples 121 to 137, wherein the one or more additively manufactured objects comprise one or more dental appliances.

Example 139. The method of any one of Examples 121 to 138, wherein the one or more additively manufactured objects are fabricated using a powder bed fusion process.

Example 140. The method of Example 139, wherein the powder bed fusion process comprises selective laser sintering.

### Conclusion

Although many of the embodiments are described above with respect to systems, devices, and methods for manufacturing and processing dental appliances, the technology is applicable to other applications and/or other approaches, such as manufacturing and processing of other types of additively manufactured objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-20.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving one or more additively manufactured objects that are at least partially covered with a precursor material;
cooling the one or more additively manufactured objects and the precursor material to a target temperature; and
removing at least some of the precursor material from the one or more additively manufactured objects via application of mechanical force.

2. The method of claim 1, wherein the one or more additively manufactured objects and the precursor material are cooled within a chamber.

3. The method of claim 2, further comprising introducing an inert gas into the chamber.

4. The method of claim 3, wherein the introducing of the inert gas purges oxygen from within the chamber.

5. The method of claim 2, further comprising fluidically sealing the chamber from external air.

6. The method of claim 1, wherein the one or more additively manufactured objects and the precursor material are passively cooled.

7. The method of claim 1, wherein the one or more additively manufactured objects and the precursor material are actively cooled using at least one cooling device.

8. The method of claim 1, further comprising monitoring a cooling status of the one or more additively manufactured objects using at least one sensor.

9. The method of claim 8, wherein the cooling status comprises one or more of the following: a temperature of the one or more additively manufactured objects, a cooling rate of the one or more additively manufactured objects, a temperature of a powder cake containing the one or more additively manufactured objects, or a cooling rate of the powder cake containing the one or more additively manufactured objects.

10. The method of claim 8, further comprising determining whether the one or more additively manufactured objects have reached the target temperature based on the cooling status.

11. The method of claim 1, wherein the removing comprises brushing the one or more additively manufactured objects.

12. The method of claim 11, wherein the brushing is performed using a brush assembly.

13. The method of claim 12, wherein the brush assembly comprises a plurality of rotary brushes.

14. The method of claim 1, wherein the removing comprises agitating the one or more additively manufactured objects.

15. The method of claim 14, wherein the agitating comprises one or more of vibrating or rotating the additively manufactured object.

16. The method of claim 14, wherein the agitating is performed by a vibrating platform, a centrifuge, or a combination thereof.

17. The method of claim 1, further comprising collecting at least some of the precursor material removed from the one or more additively manufactured objects for reuse.

18. The method of claim 1, wherein the one or more additively manufactured objects comprise one or more dental appliances.

19. The method of claim 1, wherein the one or more additively manufactured objects are fabricated using a powder bed fusion process.

20. The method of claim 19, wherein the powder bed fusion process comprises selective laser sintering.
